(19) United States
(12) Patent Application Publication
(10) Pub. No.: US 2015/0259369 A1
(43) Pub. Date: Sep. 17, 2015

(54) REACTIVE EXTRUSION PROCESSES

(71) Applicant: Cyclewood Solutions, Inc., Fayetteville, AR (US)

(72) Inventor: Bernard Robert McKellar, Dallas, TX (US)

(73) Assignee: CYCLEWOOD SOLUTIONS, INC., Fayetteville, AR (US)

(21) Appl. No.: 14/660,918

(22) Filed: Mar. 17, 2015

Related U.S. Application Data
(60) Provisional application No. 61/954,170, filed on Mar. 17, 2014.

(51) Int. Cl. C07G 1/00

(52) U.S. Cl. CPC C07G 1/00

(57) ABSTRACT

One embodiment includes combining lignin, cyclic alkene carbonate, and a basic/alkaline compound and allowing the cyclic alkene carbonate and the basic/alkaline compound to modify the lignin to produce a hydroxyalkoxylated lignin. The cyclic alkene carbonate can act as a hydroxyalkoxylating reagent and the basic/alkaline compound can act as a catalyst.

### CROSS-REFERENCE TO RELATED APPLICATION

This application claims the benefit of priority under 35 U.S.C. §119(e) to U.S. Provisional Application Ser. No. 61/954,170, “REACTIVE EXTRUSION PROCESSES” filed Mar. 17, 2014 which is hereby incorporated by reference in its entirety.

### TECHNICAL FIELD

This disclosure relates in general to the field of compositions and, more particularly, to a system and method for preparing chemically modified lignin.

### BACKGROUND

A plastic material is any of a wide range of synthetic or semi-synthetic organic solids that may be moldable. Plastics are typically organic polymers of high molecular mass, but they often contain other substances. Early plastics were bio-derived materials such as egg and blood proteins, which are organic polymers. In the 1800s, the development of plastics accelerated with Charles Goodyear's discovery of vulcanization as a route to thermoset materials derived from natural rubber. After the First World War, improvements in chemical technology led to an explosion in new forms of plastics. Among the earliest examples in the wave of new polymers were polystyrene (PS) and polyvinyl chloride (PVC). The development of plastics has come from the use of natural plastic materials (e.g., chewing gum, shellac) to the use of chemically modified natural materials (e.g., rubber, nitrocellulose, collagen, galalite) and finally to completely synthetic molecules (e.g., bakelite, epoxy, PVC). Plastics are durable and degrade slowly because the chemical bonds that make plastic so durable, make it equally resistant to natural processes of degradation. As a result, most plastic we use today will either be incinerated or end up in a landfill for many years.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system and method for preparing chemically modified lignin, in accordance with one embodiment of the present disclosure;

FIG. 2 is a simplified block diagram of a system and method for preparing chemically modified lignin, in accordance with one embodiment of the present disclosure;

FIG. 3 is a simplified block diagram of a system and method for preparing chemically modified lignin, in accordance with one embodiment of the present disclosure;

FIG. 4 is a simplified block diagram of a system and method for preparing chemically modified lignin, in accordance with one embodiment of the present disclosure;

FIG. 5 is a simplified block diagram of a system and method for preparing chemically modified lignin, in accordance with one embodiment of the present disclosure;

FIG. 6 is a simplified flowchart illustrating potential operations that may be associated with an embodiment of the present disclosure;

FIG. 7 is a simplified table illustrating potential details that may be associated with an embodiment of the present disclosure;

FIG. 8 is a simplified graph illustrating potential details that may be associated with an embodiment of the present disclosure;

FIG. 9 is a simplified graph illustrating potential details that may be associated with an embodiment of the present disclosure;

FIG. 10 is a simplified graph illustrating potential details that may be associated with an embodiment of the present disclosure;

FIG. 11 is a simplified table illustrating potential details that may be associated with an embodiment of the present disclosure;

FIG. 12 is a simplified graph illustrating potential details that may be associated with an embodiment of the present disclosure;

FIG. 13 is a simplified graph illustrating potential details that may be associated with an embodiment of the present disclosure;

FIG. 14 is a simplified table illustrating potential details that may be associated with an embodiment of the present disclosure;

FIG. 15 is a simplified table illustrating potential details that may be associated with an embodiment of the present disclosure;

FIG. 16 is a simplified graph illustrating potential details that may be associated with an embodiment of the present disclosure;

FIG. 17 is a simplified graph illustrating potential details that may be associated with an embodiment of the present disclosure;

FIG. 18 is a simplified graph illustrating potential details that may be associated with an embodiment of the present disclosure;

FIG. 19 is a simplified graph illustrating potential details that may be associated with an embodiment of the present disclosure;

FIG. 20 is a simplified graph illustrating potential details that may be associated with an embodiment of the present disclosure;

FIG. 21 is a simplified graph illustrating potential details that may be associated with an embodiment of the present disclosure; and

FIG. 22 is a simplified graph illustrating potential details that may be associated with an embodiment of the present disclosure.

### DETAILED DESCRIPTION OF EXAMPLE EMBODIMENTS

Lignin is a biopolymer, abundant in nature, and is an inexpensive feedstock material, obtainable as a byproduct of the paper industry and from a variety of low-value agricultural commodities such as grasses and straw. In order for lignin to gain wider utilization as an inexpensive and biodegradable/biorenewable material, blends of lignin with thermoplastics are needed with enhanced mechanical and other useful properties. These enhanced properties should exceed those properties predictable by simple rules of mixing of the corresponding blends.

Lignin is also a complex, polydisperse material. It is polydisperse in that it is comprised of a wide distribution of molecular weight fractions. It is also complex in that the macromolecular units may further interact through hydrogen bonding and other forces, associating and re-associating, to form higher-order macromolecular combinations. The nature and degree of these higher-order macromolecular combinations/interactions contribute significantly to the mechanical (and other) properties observed in neat lignin and in lignin-thermoplastic blends, especially in those blends where the majority component is lignin. Furthermore higher-molecular-weight lignin fractions can contribute to improved material strength of materials while lower-molecular-weight lignin fractions are important for plasticization.

With new lignin extraction facilities and cellulosic ethanol plants coming online in the near future, a reliable, abundant supply of high-quality lignin is rapidly becoming available. Modified lignins can homogeneously blend with commercial, biodegradable thermoplastics affording materials with excellent mechanical properties. In particular, some of the hydroxypropyl lignin (HPL)-blended thermoplastics can be extrusion-blown into thin-film bags which can be directly substituted in the marketplace for non-sustainable, non-compostable high-density polyethylene (HDPE) shopping bags now in widespread use.

For purposes of illustrating certain example techniques of the present disclosure, the following foundational information may be viewed as a basis from which the present disclosure may be properly explained. Transesterification as a method to improve mechanical properties of lignin by improving the compatibility of an esterified lignin and a polyester thermoplastic may be limited by preferential transesterification of the lower molecular weight lignin fractions causing them to dissociate and leading to increased brittleness. In materials where it is desirable that lignin is the majority component, lignin must contribute most of the material's desired mechanical properties and not just function as a filler material. However, this requires preserving the complex macromolecular interactions that are largely responsible for lignin's mechanical strength. But at the same time, neat lignin is known to be quite brittle, so as the percentage of lignin increases in a blend, the thermoplastic component (linear-polymer) in the blend must serve increasingly as a plasticizer for the lignin as well as contributing mechanical strength on its own. A plasticizer for lignin, however, cannot weaken the lignin by disrupting its complex macromolecular interactions.

One current process for making large quantities of HPL involves several processing steps and includes the use of flammable reagents. Propylene oxide, the currently-used hydroxypropylating reagent, will not work as a reactive solvent for lignin because it is too non-polar to dissolve the polar groups of lignin and its boiling point (30° C.) is too low to allow heating as a means of increasing solubility. Heating propylene oxide under pressure is also not a viable option since heated propylene oxide vapor is quite explosive, even in the absence of oxygen. A different hydroxypropylating reagent is needed to allow for an alternative HPL manufacture process (i.e., a suitable reactive solvent and a solvent functioning as an inexpensive lignin hydroxypropylating reagent while also readily dissolving lignin).

In addition, considerable cost savings could be realized if there were fewer steps in the HPL synthesis process. For example, if the hydroxypropylation reaction could be conducted neat (that is, with no added solvent) rather than in an aqueous solution, then several of the present steps could be eliminated, including precipitation, filtration, washing, and drying, along with the concomitant material handling steps between these operations. Furthermore, a neat reaction would obviate the labor and materials needed to prepare the reaction solution and would allow the use of smaller reactors.

In addition to production cost savings, preparing HPL by a neat reaction or a reaction where no added solvent other than the reagent is added would be a more environmentally benign manufacturing process and could reduce the generation of process waste. However, since dry lignin is a solid and since Kraft lignin chars before it melts, a neat or no added solvent, other than the reagent homogeneous liquid-phase reaction, is feasible only in the presence of a reactive solvent. By using a reagent for the hydroxypropylation reaction which also can readily dissolve lignin. It would be beneficial if hydroxylpropyl lignin and other chemically-modified lignins could be produced by a more efficient and more environmentally benign process that has little or no solvent use, limited operational and transfer steps involved in the work-up (i.e., isolation and purification steps), no side products or waste stream to be disposed, recyclable catalysts, a small equipment footprint, low energy consumption, safe recoverable inexpensive reagents, on-demand production capacity such as obtainable from a continuous process, and process flexibility (i.e., the capability of producing a variety of types and combinations of lignin chemical reactions produced from the use of the same basic process equipment).

In an illustrative example, a continuous reactive extrusion process may use propylene carbonate as reactive solvent and aromatic, aliphatic or heterocyclic amines such as tributylamine, imidazole and imidazole derivatives as non-nucleophilic bases (e.g., compounds with pKAs of conjugate acids that demonstrate the capability of de-protonating phenols), which are also volatile (e.g., with boiling points comparable to propylene carbonate) and therefore useful as reaction catalysts, may be used for chemically modifying lignin.

Alkylene carbonates can react with aromatics containing substituents which have acidic protons or active hydrogens, (e.g., compounds such as phenols, thiophenols, aniline and the like). Using alkene and alkyl carbonates as reactive solvents is safer than oxiranes such as propylene oxide and other compounds currently being used and requires fewer, if any, of the safeguards against fire and explosion. More specifically, propylene carbonate and other alkene carbonates can function as solvents for lignin as well as functioning as reagents. One reason is that propylene carbonate has a favorably high boiling point (243° C.) and a high dielectric constant (65). This is in contrast to propylene oxide and other oxiranes which are poor solvents for Kraft lignin and require initial dissolution of lignin in a strong aqueous base in order to be reactive. Consequently, the use of propylene carbonate and other alkene carbonates as “reactive solvents” has several advantages. For example, the use of propylene carbonate and other alkene carbonates obviates the use of aqueous sodium hydroxide to dissolve raw lignin and can result in reduced material costs, safety hazards, handing, etc. Further, the absence of added water, or use of an aqueous solution, eliminates or mitigates the hydrolysis of the hydroxypropylation reagent. The use of a reactive solvent allows for a more concentrated reaction mixture and, therefore, allows employment of more compact reaction vessels as well as other advantages that can be gained by using a more compact reaction vessel. Also, any excess propylene carbonate can be distilled from the reaction mixture and recovered and/or recycled back into the process. In contrast propylene oxide is less amenable to recovery or recycling.

Further, aromatic, aliphatic or heterocyclic amines such as tributylamine, imidazole and imidazole derivatives including 1-methylimidazole may be used as an alkaline catalyst. Various types of alkaline compounds and other compounds can catalyze alkene carbonate and alkyl carbonate reactions in the presence of active hydrogen compounds. In one example, a basic/alkaline compound includes an aliphatic, heterocyclic or aromatic amine having a pKa dissociation constant in the range of about 9 to about 13. In another example, tri(2-hydroxyethyl)isocyanurate can be prepared from ethylene carbonate and isocyanuratic acid using a catalyst that has at least one amine functional group. In one example, aromatic, aliphatic or heterocyclic amines in general and tri-n-butylamine and 1-methylimidazole in particular may be used as alkaline catalysis for reactions with lignin. More specifically, the pKa conjugate acid=7.4 of 1-methylimidazole allows 1-methylimidazole to deprotonate phenols. Because 1-methylimidazole has a boiling point (198° C.) similar to propylene carbonate's boiling point, during work-up (isolation and purification), 1-methylimidazole and other amines can be distilled from the reaction mixture simultaneously with the evaporation of any residual propylene carbonate. The pKa of 10.89 of the conjugate acid of tri-n-butylamine allows tri-n-butylamine to deprotonate phenol. Because tri-n-butylamine has a boiling point (216° C.), similar to propylene carbonate's boiling point, during work-up (isolation and purification), tri-n-butylamine can be distilled from the reaction mixture simultaneously with the evaporation of any residual propylene carbonate. These properties of particular selected volatile amines of sufficient basicity comprising tributylamine and 1-methylimidazole, among others, allow for a simplified process and facilitates the implementation of a continuous reactive extrusion process with its concomitant advantages. Alkali metal and other ionic alkaline catalysts are difficult to distill and therefore, are typically removed by acid neutralization followed by cumbersome filtration or extraction steps. Such steps cannot be readily incorporated into a continuous reactive extrusion process and therefore the advantages of reactive extrusion cannot be attained with current alkali metal catalysts.

Both 1-methylimidazole and tri-n-butylamine are effective basic catalyst, to some degree, for the hydroxypropoxylation reaction of lignin, however reactions using 1-methylimidazole at temperatures greater than 160° C. have consistently shown the production of a gel-like pyridine-insoluble fraction (about 30% by weight) after the devolitilization step, while, in contrast, the lignin product produced from a hydroxypropylation reaction using tri-n-butylamine is typically completely soluble in pyridine after the devolitilization operation. Use of tribuyl amine in the lignin hydroxypropylation reaction can mitigate one or more of the factors that may cause the generation of pyridine-insoluble gel-like fractions. Further, sterically-hindered amines can function as free-radical scavengers and the polarity of the counterions (cations derived from bases) comprising salts of organic acids (such as carboxylic acid and phenol salts) can substantially affect the solubility of organic-acid salts. The physical and chemical properties of tri-n-butylamine likely contribute to the observed mitigation of the pyridine-insoluble, gel-like fraction formation. More specifically, tri-n-butylamine, as indicated by the pKa of its conjugate acid of 10.89, is a stronger base than 1-methylimidazole (which has a measured pKa of its conjugate base of 7.4). Also, tri-n-butylamine is immiscible with propylene carbonate and with water. Tri-n-butylamine is a sterically hindered base due to the bulk of the butyl groups, is relatively very low in its polarity, and has a higher boiling point (216° C.) than 1-methylimidazole (198° C.). Other amines or other bases, in general, which possess some or all of the properties or characteristics of tri-n-butylamine, may be effective hydroxylpropoxylation catalysts with the added advantage of obviating or mitigating the formation of undesirable pyridine-insoluble fractions.

In one example, lime may be used as a base catalyst. Lime is a relatively inexpensive material, especially when compared to tributylamine. In addition, tributylamine may not be basic enough to totally deprotonate many of the less acidic phenolic hydroxyl groups on lignin, thus limiting the extent of the polycaprolactone hydroxypropylation. Even in reacting with the more acidic phenols, tributylamine may not be basic enough to shift the equilibrium to the right and thus the reaction rate is slowed due to the limitation of phenolate anions to react with polycaprolactone. The carbon dioxide produced in the propylene carbonate reaction can neutralize the tributylamine, acidifying the mixture, and thus slowing the reaction rate. The carbon dioxide produced in the propylene carbonate reaction requires venting which complicates reactive extrusion extruder design due to extruder vent flow and other issues. The tributyl amine liquid also requires devolitalization, thus requiring more extruder length and requiring vacuum pumps and heating and creating increased energy costs. Further, the tributylamine lowers the mixture viscosity the reducing mechanical (mixing) heating in a RE process. Residual tributylamine could be a problem for smell and food contact certification in commerce. The current as-received lignin contains about 30% moisture which (probably) requires pre-drying of the lignin before the reactive extrusion process. Time and money could be saved by eliminating or modifying this drying step. Calcium carbonate is typically a filler added to the lignin/thermoplastic blend thus Calcium carbonate residue in the lignin would not be a problem for some applications.

In a specific illustrative example, raw (about 30%-moisture) lignin can be mixed with CaO (e.g., calcium oxide, lime). The moisture in the lignin produces calcium hydroxide from the calcium oxide (CaO+H2O (wet lignin) to Ca(OH)2 (and dryer lignin)) and the lime can function as a drying agent for the moist lignin. Calcium hydroxide deprotonates the wet lignin phenol-type groups to phenolate anions (Ca(OH)2+2 lignin-OH to 2 lignin-O—Ca⁺⁺+2 H2O). In a reactor such as a reactive extruder, propylene carbonate can be added and heated causing the phenolate anions to react with propylene carbonate and produce hydroxypropyl lignin as some or all of the CO2 becomes calcium carbonate (2 lignin-O—Ca⁺⁺+2 propylene carbonate to 2 hydroxypropyl lignin+CaCO2+CO2).

Another example includes a system and method that may be integrated with many common wood-pulping processes and more particularly with the kraft pulping process. In the kraft pulping process, cellulose is separated from a strongly alkaline sodium hydroxide-and-lignin-containing-solution known as black liquor. Typically, the black liquor is initially acidified by passing carbon dioxide gas through the solution, after which the pH of the solution can be reduced to approximately pH 9-10. The lignin can be caused to separate from the concentrated black liquor as a wet solid by concentrating the partially-acidified black liquor or by other methods. This pH 9-10 lignin may be combined with propylene carbonate and heated to temperatures greater than 150° C., causing the remainder of the water to be volatilized and the alkaline lignin to react with propylene carbon to form hydroxypropyl lignin.

In addition, cyclic alkylene carbonates can be used as reactive solvents and amines can be used as alkaline catalyst in a continuous or semi-continuous reaction process such as a one-pot reaction or one-pot synthesis. The terms “one-pot reaction” and “one-pot synthesis” are to include a continuous or semi-continuous reaction process where the reactants are subjected to chemical reactions in just one reactor, vessel, or pot and avoid the separation and purification of intermediate chemical compounds. More specifically, a hydroxypropylation reaction using propylene carbonate can be conducted neat. The alkylene carbonate reaction can eliminate or reduce several steps, including, but not limited to acid precipitation, filtration, washing and drying. Also reduced is the concomitant material handling steps between these operations. The neat reaction in an alkylene carbonate allows the use of smaller reactors and vessels than used in the propylene oxide reaction.

In an example, a process can include employing propylene carbonate to prepare hydroxypropylated lignin (HPL). HPL is a material which has been demonstrated to blend homogenously with certain commercial thermoplastics, including polybutylene adipate terephthalate (PBAT), such that the resulting blended thermoplastic material is suitable for producing extrusion-blown plastic bags as well as having utility in fabricating molded and extruded thermoplastic articles. In a more general aspect, ethylene carbonate and other cyclic carbonates may also be employed to produce chemically-modified lignins analogous to HPL, that is, to be comprised of hydroxyethylated lignin and its homologues. In another general aspect, dialkyl carbonates such as diethylcarbonate, dimethylcarbonate and the like may be employed by the processes disclosed to afford corresponding alkyloxylignins. These lignins, comprised of alkylether groups, are less polar than hydroxyalkylated groups, and therefore blend well with non-polar-type thermoplastics such as polyethylene and polypropylene thus affording lignin-containing thermoplastics suitable for use substitution for polyethylene and polypropylene in a great diversity of manufactured articles such as films and fibers where these polyolefins are currently employed.

The general alkylcarbonate chemical reaction is applicable to the manufacture of a variety of chemically modified lignins. In another aspect, the reaction, in several of its features, is particularly favorable for one-pot reactions, continuous or semi-continuous processes or reactions, and reactive extrusion chemical processing which has several advantages over typical batch processes. The reactive extrusion process as applied to the manufacture of chemically modified lignins is still another aspect with broad applications to the chemical modification of lignin and to articles of manufacture produced from such materials. The continuous reactive extrusion aspect can be extended beyond alkylcarbonates reactions to still other simple solvent-free chemical reactions which may be caused to take place in the presence of lignin's reactive phenols and with other groups present in lignin.

In reactive extrusion processing, caprolactone, for example, may be reacted in a reactive extruder in the presence of lignin and in the presence of certain catalysts to produce a polycaprolactone-functionalized lignin by means of a ring-opening polymerization. Similarly other cyclic lactones may be utilized to produce other polyester-functionalized lignins and in a further aspect, cyclic lactams may be used to produce polyamide functionalized lignins by reactive extrusion. In still another aspect, multi-functionally-modified lignins may be prepared by adding various combinations of reagents, either simultaneously or sequential, to the continuous reactive extrusion process. Thus various combinations and permutations of functional groups and/or oligomers may be added to lignin in order to tailor its properties to produce materials suitable for a wide variety of applications.

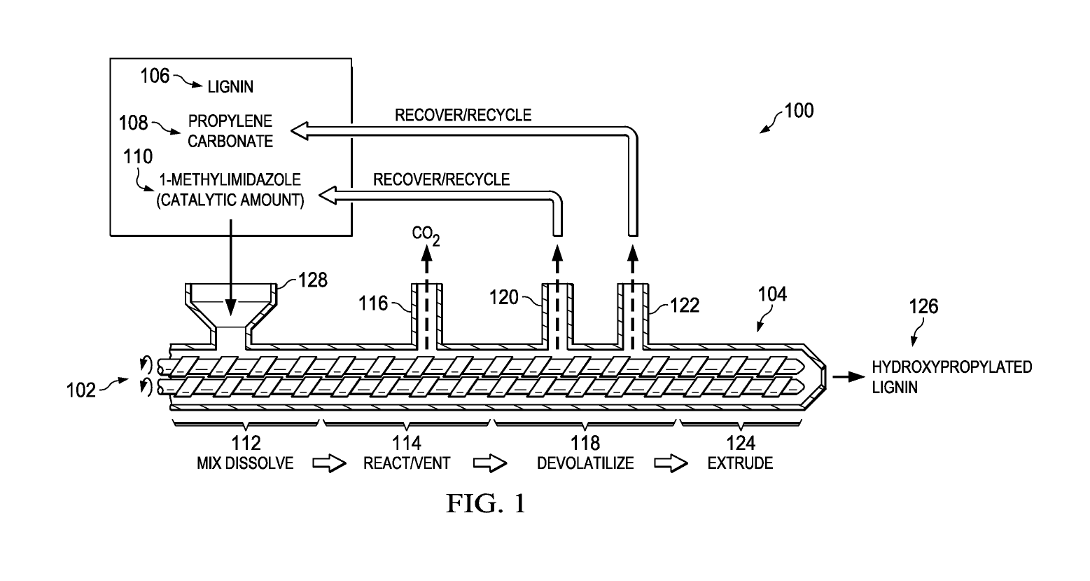

FIG. 1 illustrates an example embodiment of a continuous reactive extrusion process to prepare HPL. While the example embodiment is of a continuous reactive extrusion process, it should be appreciated that the illustrated example is readily applicable to other continuous or semi-continuous processes. As illustrated in FIG. 1, lignin 106 (e.g., raw Kraft lignin), propylene carbonate 108, and 1-methylimidazole 110 are metered from one or more hoppers 128 into a stream 102 in a screw conveyer 104 (e.g., a twin-screw conveyer). Stream 102 may be a non-aqueous reaction media where the lignin is modified. One or more hoppers 128 may be a reservoir or some other container, vessel, or storage system that allows the lignin 106, the propylene carbonate 108, and the 1-methylimidazole 110 to be metered into screw conveyer 104. The lignin 106, the propylene carbonate 108, and the 1-methylimidazole 110 may be pre-mixed or metered into screw conveyer 104 separately.

During a mixing and dissolve stage 112, the lignin 106, the propylene carbonate 108, and the 1-methylimidazole 110 are mixed together. Upon heating, the mixture becomes molten and upon further passage along the screw conveyer 104, during a react and vent stage 114, higher temperatures induce a propylene carbonate hydroxypropylation reaction with concurrent venting of evolved carbon dioxide 116. Upon further passage through the screw conveyer 104, during a devolitalize stage 118, the molten reaction mass encounters a vacuum where the volatiles (1-methyl imidazole and any remaining propylene carbonate) are distilled-off. For example, FIG. 1 illustrates 1-methylimidazole 110 venting 120 and propylene carbonate 108 venting 122. The vented 1-methylimidazole 110 and propylene carbonate 108 can be recovered and recycled. The devolatilized HPL will remain molten because, unlike un-modified lignin, HPL melts before it chars. Thus the molten HPL can pass through an extrusion die to be cooled and pelletized during an extruding stage 124. The chemically modified lignin, in this example, HPL 126 can be collected in a hopper for storage or can be further processed. Subsequently, the modified lignin (HPL pellets) can be fed into a separate extruder for melt-blending/compounding with another thermoplastic such as PBAT.

Advantages of a continuous or semi-continuous reaction process, such as the illustrative reactive extrusion process, to prepare HPL over stirred reactor processes and other batch operations include a more rapid heat and mass transfer, a better high-sheer mixing, and improved overall reaction conditions. Further advantages can include efficient processing of viscous reaction mixture and continuous operational and transfer steps. Carbon dioxide is the only side product and can be safely vented to the atmosphere, as illustrated by venting of evolved carbon dioxide 116. Also, since carbon dioxide is used to synthesize propylene carbonate, the carbon dioxide may not be permanently released to the environment but can be recycled when more propylene carbonate is prepared. The equipment used in the process can include a small equipment footprint-continuous reactive extruder which is more compact than production scale reactors and the process has an overall relatively low energy consumption. Another advantage is that solvents reagents and catalysts (e.g., 1-methylimidazole 110 and propylene carbonate 108) can be recovered and recycled (e.g., using 1-methylimidazole 110 venting 120 and propylene carbonate 108 venting 122) and as a result, environmental impact can be lessened and cost may be saved. In addition, on-demand production capacity is obtainable due to the continuous process of material. Further, the process has the capability of producing a variety of types and combinations of lignin chemical reactions using the same basic process equipment.

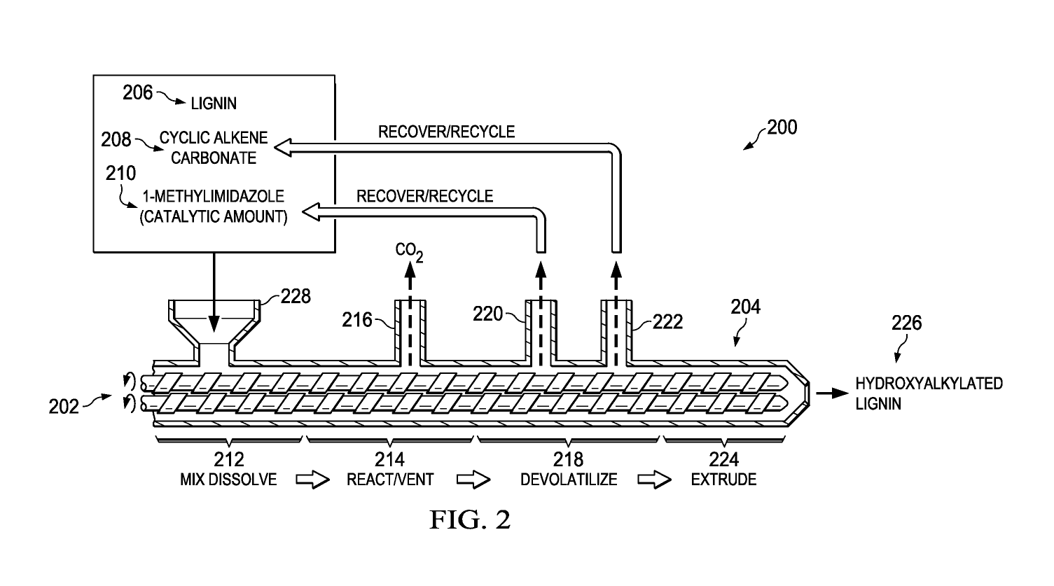

Turning to FIG. 2, FIG. 2 illustrates an example embodiment of a continuous reactive extrusion process to prepare hydroxyalkoxylated lignins in general. While the example embodiment is of a continuous reactive extrusion process, it should be appreciated that the illustrated example is readily applicable to other continuous or semi-continuous processes. As illustrated in FIG. 2, lignin 206 (e.g., raw Kraft lignin), cyclic alkene carbonate 208, and 1-methylimidazole 210 are metered from one or more hoppers 228 into a stream 202 in a screw conveyer 204 (e.g., a twin-screw conveyer). Stream 202 may be a non-aqueous reaction media where the lignin is modified. One or more hoppers 228 may be a reservoir or some other container, vessel, or storage system that allows the lignin 206, the cyclic alkene carbonate 208, and the 1-methylimidazole 210 to be metered into screw conveyer 204. The lignin 206, the cyclic alkene carbonate 208, and the 1-methylimidazole 210 may be pre-mixed or metered into screw conveyer 204 separately. The cyclic alkene carbonate 208 includes compounds with n=2 to 20 carbons in the ring and with n=0 to 30 extracyclic carbons.

During a mixing and dissolve stage 212, the lignin 206, the cyclic alkene carbonate 208, and the 1-methylimidazole 210 are mixed together. Upon heating, the mixture becomes molten and upon further passage along the screw conveyer 204, during a react and vent stage 214, higher temperatures induce a cyclic alkene carbonate hydroxyalkylation reaction with concurrent venting of evolved carbon dioxide 216. Upon further passage through the screw conveyer 204, during a devolitalize stage 218, the molten reaction mass encounters a vacuum where the volatiles (1-methyl imidazole and any remaining cyclic alkene carbonate) are distilled-off or evaporated from the mixture. For example, FIG. 2 illustrates 1-methylimidazole venting 220 and cyclic alkene carbonate venting 222. The vented 1-methylimidazole 210 and cyclic alkene carbonate 208 can be recovered and recycled. The devolatilized hydroxyalkylated lignin will remain molten because, unlike un-modified lignin, the hydroxyalkylated lignin melts before it chars. Thus the molten the hydroxyalkylated lignin can pass through an extrusion die to be cooled and pelletized during an extruding stage 224. The chemically modified lignin, in this example, hydroxyalkylated lignin 226 can be collected in a hopper for storage or can be further processed. Subsequently, the modified lignin (hydroxyalkylated lignin pellets) can be fed into a separate extruder for melt-blending with another thermoplastic such as PBAT.

Advantages of a continuous or semi-continuous reaction process, such as the illustrative continuous reactive extrusion process, to prepare hydroxyalkoxylated lignins over stirred reactor processes and other batch operations include more rapid heat and mass transfer, better high-sheer mixing, and improved overall reaction conditions. Further advantages can include efficient processing of viscous reaction mixture and continuous operational and transfer steps. Carbon dioxide is the only side product and can be safely vented to the atmosphere Also, since carbon dioxide is used to synthesize alkylene carbonates, the carbon dioxide may not be permanently released to the environment but can be recycled when more propylene carbonate is prepared. The equipment used in the process includes small equipment footprint-continuous reactive extruders which are more compact than production scale reactors and the process has an overall relatively low energy consumption. Another advantage is that solvents reagents and catalysts (e.g., cyclic alkene carbonate 208, and 1-methylimidazole 210) are recovered and recycled (e.g., during 1-methylimidazole venting 220 and cyclic alkene carbonate venting 222) and as a result environmental impact can be lessened and cost may be saved. In addition, on-demand production capacity is obtainable due to the continuous process of material. Further, the process has the capability of producing a variety of types and combinations of lignin chemical reactions using the same basic process equipment.

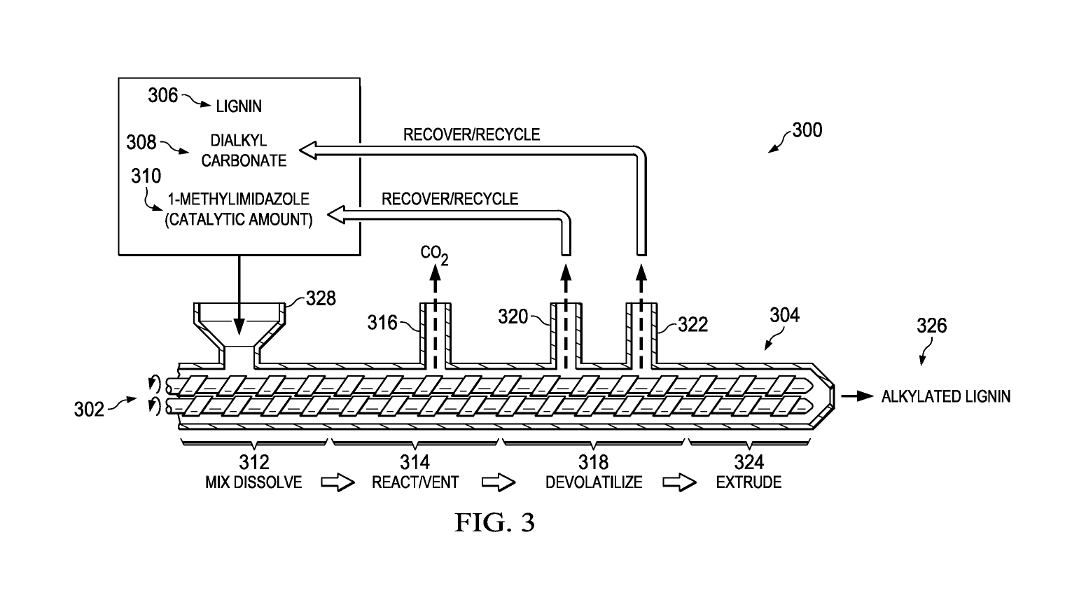

Turning to FIG. 3, FIG. 3 illustrates an example embodiment of a continuous reactive extrusion process to prepare alkyl-modified lignins in general. While the example embodiment is of a continuous reactive extrusion process, it should be appreciated that the illustrated example is readily applicable to other continuous or semi-continuous processes. As illustrated in FIG. 3, lignin 306 (e.g., raw Kraft lignin), dialkyl carbonate 308, and 1-methylimidazole 310 are metered from one or more hoppers 328 into a stream 302 in a screw conveyer 304 (e.g., a twin-screw conveyer). Stream 302 may be a non-aqueous reaction media where the lignin is modified. One or more hoppers 328 may be a reservoir or some other container, vessel, or storage system that allows the lignin 306, the dialkyl carbonate 308, and the 1-methylimidazole 310 to be metered into screw conveyer 304. The lignin 306, the dialkyl carbonate 308, and the 1-methylimidazole 310 may be pre-mixed or metered into screw conveyer 304 separately. The dialkyl carbonate 308 includes compounds with n=2 to 100 carbons, straight chain or branched carbon chains, and a volatile alkaline catalyst.

During a mixing and dissolve stage 312, the lignin 306, the dialkyl carbonate 308, and the 1-methylimidazole 310 are mixed together. Upon heating, the mixture becomes molten and upon further passage along the screw conveyer 304, during a react and vent stage 314, higher temperatures induce a dialkyl carbonate alkylation reaction with concurrent venting of evolved carbon dioxide 316. Upon further passage through the screw conveyer 304, during a devolitalize stage 318, the molten reaction mass encounters a vacuum where the volatiles (1-methyl imidazole and any remaining dialkyl carbonate) are distilled-off or evaporated from the mixture. For example, FIG. 3 illustrates 1-methylimidazole venting 320 and dialkyl carbonate venting 322. The vented 1-methylimidazole 310 and dialkyl carbonate 308 can be recovered and recycled. The devolatilized the alkylated lignin will remain molten because, unlike un-modified lignin, the alkylated lignin melts before it chars. Thus the molten alkylated lignin can pass through an extrusion die to be cooled and pelletized during an extruding stage 324. The chemically modified lignin, in this example, halkylated lignin 326, can be collected in a hopper for storage or can be further processed. Subsequently, the modified lignin (hydroxyalkylated lignin pellets) can be fed into a separate extruder for melt-blending with another thermoplastic such as PBAT.

Advantages of a continuous or semi-continuous reaction process, such as the illustrative reactive extrusion process, to prepare alkyl-modified lignins over stirred reactor processes and other batch operations include a more rapid heat and mass transfer, a better high-sheer mixing, and improved overall reaction conditions. Further advantages can include efficient processing of viscous reaction mixture and continuous operational and transfer steps. Carbon dioxide is the only side product and can be safely vented to the atmosphere Also, since carbon dioxide is use to synthesize dialkyl carbonates, the carbon dioxide may not be permanently released to the environment but can be recycled when more dialkyl carbonate is prepared. The equipment used in the process includes small equipment footprint-continuous reactive extruders which are more compact than production scale reactors and the process has an overall relatively low energy consumption. Another advantage is that solvents reagents and catalysts (e.g., dialkyl carbonates 308 and 1-methylimidazole 310) are recovered and recycled (e.g., during 1-methylimidazole venting 320 and dialkyl carbonate venting 322) and as a result, environmental impact can lessened and cost may be saved. In addition, on-demand production capacity is obtainable due to the continuous process of material. Further, the process has the capability of producing a variety of types and combinations of lignin chemical reactions using the same basic process equipment.

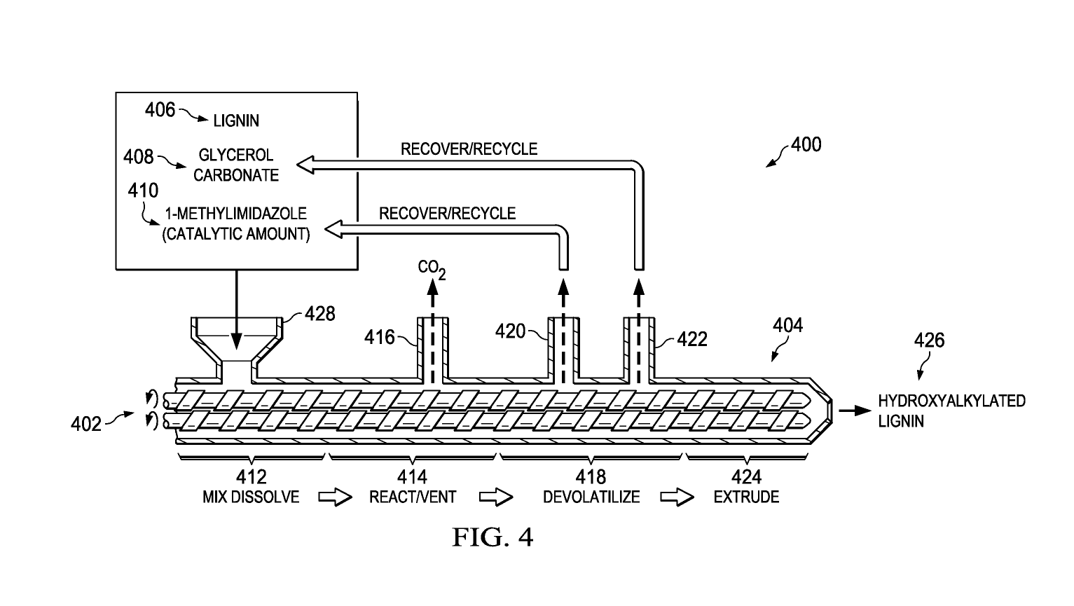

Turning to FIG. 4, FIG. 4 illustrates an example embodiment of a continuous reactive extrusion process to prepare hydroxyalkoxylated lignins in general. While the example embodiment is of a continuous reactive extrusion process, it should be appreciated that the illustrated example is readily applicable to other continuous or semi-continuous processes. As illustrated in FIG. 4, dried lignin 406 (e.g., raw Kraft lignin), glycerol carbonate 408, and 1-methylimidazole 410 are metered from one or more hoppers 428 into a stream 402 in a screw conveyer 404 (e.g., a twin screw conveyer). Stream 402 may be a non-aqueous reaction media where the lignin is modified. One or more hoppers 428 may be a reservoir or some other container, vessel, or storage system that allows the lignin 406, the glycerol carbonate 408, and the 1-methylimidazole 410 to be metered into screw conveyer 404. The lignin 406, the glycerol carbonate 408, and the 1-methylimidazole 410 may be pre-mixed or metered into screw conveyer 404 separately.

During a mixing and dissolve stage 412, the lignin 406, the glycerol carbonate 408, and the 1-methylimidazole 410 are mixed together. Upon heating, the mixture becomes molten and upon further passage along the screw conveyer 404, during a react and vent stage 414, higher temperatures induce a glycerol carbonate hydroxyalkylation reaction with concurrent venting of evolved carbon dioxide 416. Upon further passage through the screw conveyer 404, during a devolitalize stage 418, the molten reaction mass encounters a vacuum where the volatiles (1-methyl imidazole and any remaining glycerol carbonate) are distilled-off or evaporated from the mixture. For example, FIG. 4 illustrates 1-methylimidazole venting 420 and glycerol carbonate venting 422. The vented 1-methylimidazole 410 and glycerol carbonate 408 can be recovered and recycled. The devolatilized hydroxyalkylated lignin will remain molten because, unlike un-modified lignin, the hydroxyalkylated lignin melts before it chars. Thus the molten the hydroxyalkylated lignin will pass through an extrusion die, to be cooled, and pelletized during an extruding stage 424. The chemically modified lignin, in this example, hydroxyalkylated lignin 426 can be collected in a hopper for storage or can be further processed. Subsequently, the modified lignin (hydroxyalkylated lignin pellets) can be fed into a separate extruder for melt-blending with another thermoplastic such as PBAT.

Advantages of a continuous or semi-continuous reaction process, such as the illustrative continuous reactive extrusion process, to prepare hydroxyalkoxylated lignins over stirred reactor processes and other batch operations include more rapid heat and mass transfer, better high-sheer mixing, and improved overall reaction conditions. Further advantages can include efficient processing of viscous reaction mixture and continuous operational and transfer steps. Carbon dioxide is the only side product and can be safely vented to the atmosphere Also, since carbon dioxide is use to synthesize dialkyl carbonates, the carbon dioxide may not be permanently released to the environment but can be recycled when more dialkyl carbonate is prepared. The equipment used in the process includes small equipment footprint-continuous reactive extruders which are more compact than production scale reactors and the process has an overall relatively low energy consumption. Another advantage is that solvents reagents and catalysts (e.g., glycerol carbonate 408, and 1-methylimidazole 410) are recovered and recycled (e.g., during 1-methylimidazole venting 420 and glycerol carbonate venting 422) and as a result, environmental impact can be lessened and cost may be saved. In addition, on-demand production capacity is obtainable due to the continuous process of material. Further, the process has the capability of producing a variety of types and combinations of lignin chemical reactions using the same basic process equipment.

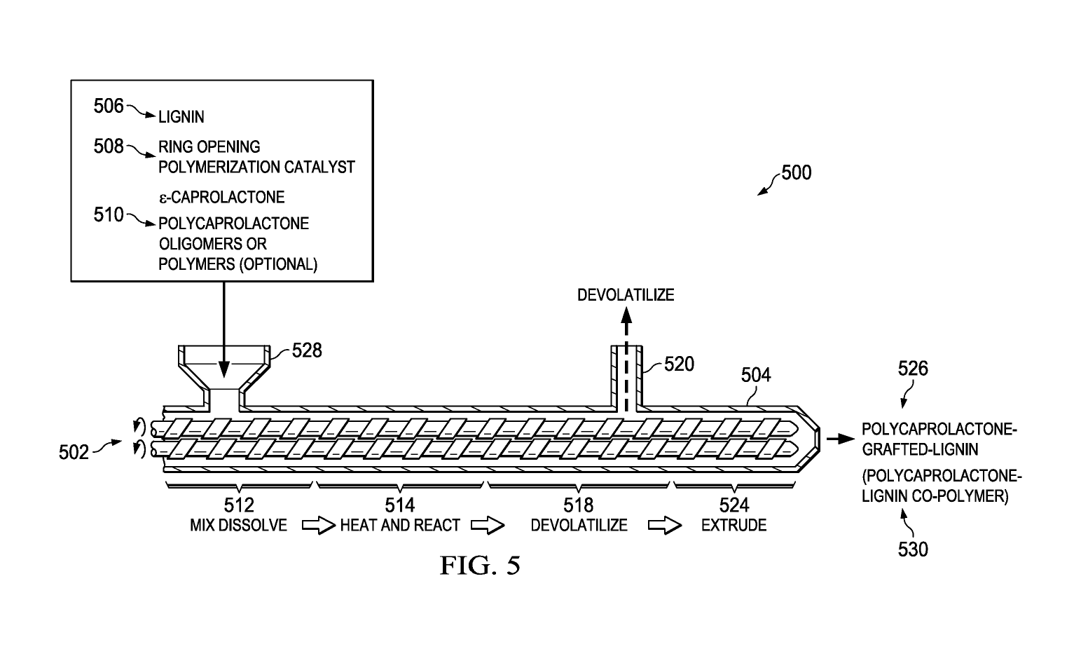

Turning to FIG. 5, FIG. 5 illustrates an example embodiment of a continuous reactive extrusion process to prepare polycaprolcactone-grafted-lignins and polycaprolactone-lignin co-polymers in general. While the example embodiment is of a continuous reactive extrusion process, it should be appreciated that the illustrated example is readily applicable to other continuous or semi-continuous processes. As illustrated in FIG. 5, lignin 506 (e.g., raw Kraft lignin) and ring-opening polymerization catalyst 508 are metered from one or more hoppers 528 into a stream 502 in a screw conveyer 504 (e.g., a twin-screw conveyer). Stream 502 may be a non-aqueous reaction media where the lignin is modified. One or more hoppers 528 may be a reservoir or some other container, vessel, or storage system that allows the lignin 506 and the ring opening polymerization catalyst 508 to be metered into screw conveyer 504. In one example, polycaprolactone oligomers or polymers 510 may also be metered from one or more hoppers 528 into screw conveyer 504. The lignin 506 and the ring opening polymerization catalyst 508 (and polycaprolactone oligomers or polymers 510 if present) may be pre-mixed or metered into screw conveyer 504 separately.

During a mixing and dissolve stage 512, the lignin 506, the ring opening polymerization catalyst 508, and the polycaprolactone oligomers or polymers 510 (if the polycaprolactone oligomers or polymers 510 are added) are mixed together. Upon heating, the mixture becomes molten and upon further passage along the screw conveyer 504, during a hear and react stage 514, higher temperatures induce a polycaprolactone reaction with the lignin 506. Upon further passage through the screw conveyer 504, during a devolitalize stage 518, the molten reaction mass encounters a vacuum where volatiles can be distilled-off or evaporated from the mixture. For example, FIG. 5 illustrates volatiles venting 520. Generally ring-opening polymerization (ROP) catalysts may not be volatile enough to remove by evaporation or distillation but since they are used only in trace amount they can be left in the material without significant problems. Polycaprolactone monomers and polymers typically will not be volatile and will likely react and bind to the lignin. The polycaprolactone-grafted-lignins and polycaprolactone-lignin co-polymers (if present due to the use of the polycaprolactone oligomers or polymers 510) will remain molten because, unlike un-modified lignin, the polycaprolactone-grafted-lignins and polycaprolactone-lignin co-polymers melt before they chars. Thus the molten polycaprolactone-grafted-lignins and polycaprolactone-lignin co-polymers can pass through an extrusion die to be cooled and pelletized during an extruding stage 224. The chemically modified lignin, in this example, polycaprolactone-grafted-lignins 526 and polycaprolactone-lignin co-polymers 530 can be collected in a hopper for storage or can be further processed. Subsequently, the modified lignin (polycaprolactone-grafted-lignins and polycaprolactone-lignin co-polymers pellets) can be fed into a separate extruder for melt-blending with another thermoplastic such as PBAT.

Advantages of a continuous or semi-continuous reaction process, such as the illustrative continuous reactive extrusion process, to prepare polycaprolcactone-grafted-lignins and polycaprolactone-lignin co-polymers over stirred reactor processes and other batch operations include more rapid heat and mass transfer, better high-sheer mixing, and optimized overall reaction conditions by the use of well-designed screw configurations. Further advantages can include efficient processing of viscous reaction mixture and continuous operational and transfer steps. The equipment used in the process includes small equipment footprint-continuous reactive extruders which are more compact than production scale reactors and the process has an overall relatively low energy consumption. Another advantage is on-demand production capacity, obtainable due to the flexibility of continuous processes to do both large and small production runs. Further, the process has the capability of producing a variety of types and combinations of lignin chemical reactions using the same basic process equipment.

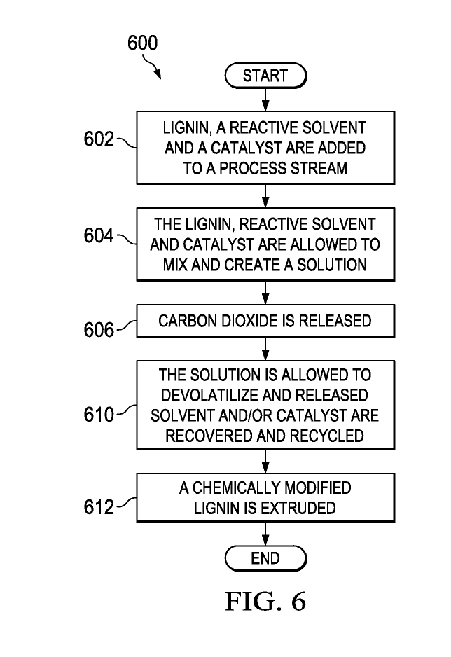

Turning to FIG. 6, FIG. 6 is an example flowchart illustrating possible operations of a flow 600 that may be associated with a reactive extrusion process for chemically modifying lignin, in accordance with an embodiment. While the example embodiment is of a continuous reactive extrusion process, it should be appreciated that the illustrated example is readily applicable to other continuous or semi-continuous processes. In an embodiment, at 602, lignin, a reactive solvent, and a catalyst are added to a process stream. For example, dried lignin 106, propylene carbonate 108, and 1-methylimidazole 110 may be added to process stream 102. At 604, the lignin, reactive solvent, and catalyst are allowed to mix and create a solution. For example, during mixing and dissolve stage 112, dried lignin 106, propylene carbonate 108, and 1-methylimidazole 110 may be allowed to mix and create a solution. At 606, carbon dioxide (if any is present) is released. For example, the carbon dioxide may be release during venting of evolved carbon dioxide 116. At 610, the solution is allowed to devolatilize and released solvent and/or catalyst (if any is present) are recovered and recycled. For example, 1-methylimidazole 110 and/or propylene carbonate 108 may be recovered and recycled using 1-methylimidazole 110 venting 120 and propylene carbonate 108 venting 122. In one example, the released solvent and/or catalyst may be recovered by not recycled. At 612, a chemically modified lignin is extruded.

Note that with the examples provided below many of the compositions, materials, percentages, etc. discussed herein could readily be changed, modified, altered, or substituted with different materials without departing from the teachings of the present disclosure. It is similarly imperative to note that the operations and steps described illustrate only some of the possible scenarios that may be executed by, or within, the systems and methods of the present disclosure. Some of these operations may be deleted or removed where appropriate, or these steps may be modified or changed considerably without departing from the scope of the discussed concepts.

In a general example, transesterification experiments were conducted by reintroducing approximately 60 g samples of modified lignin prepared using one or more of the above examples to the high shear mixer while varying the chemical catalyst, the transesterifcation temperatures, and the transesterification times. The chemical catalyst was varied by using no catalyst, zinc acetate (1 wt %,), and zinc acetate with titanium(IV)butoxide (1 wt %). The transesterification temperatures were varied to 200° C. and 225° C. The transesterification times were verified by using a transesterification time of 10 min, 30 min, and 60 minutes After an experiment was completed, the completed batch was removed from the mixer, cooled, and analyzed.

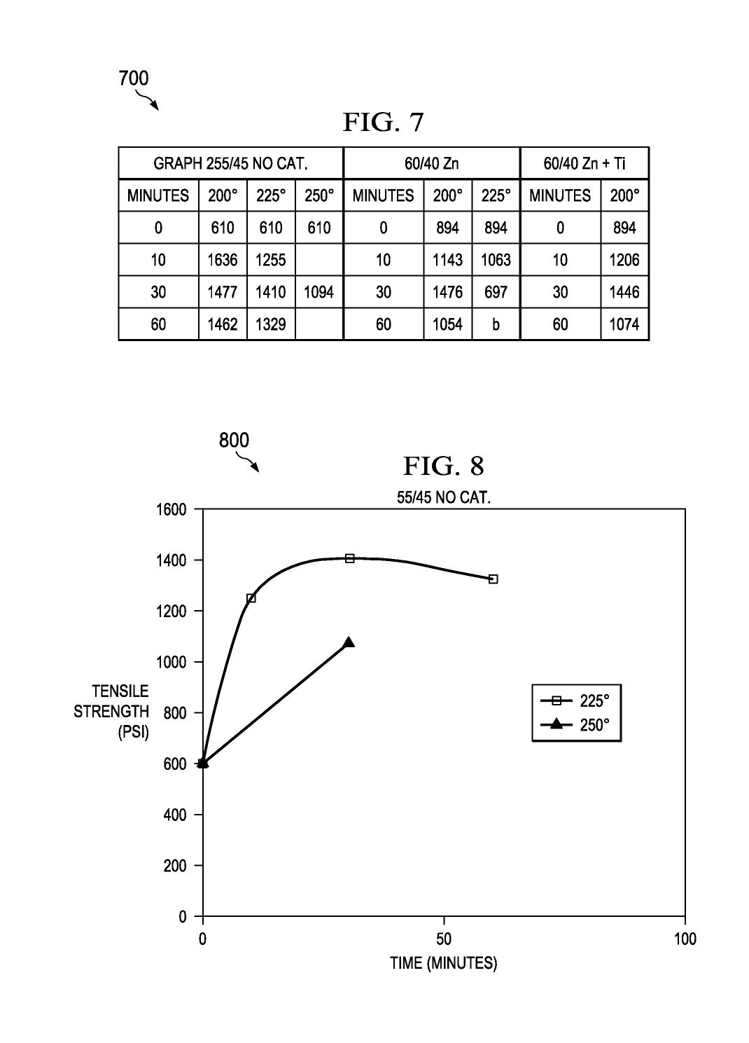

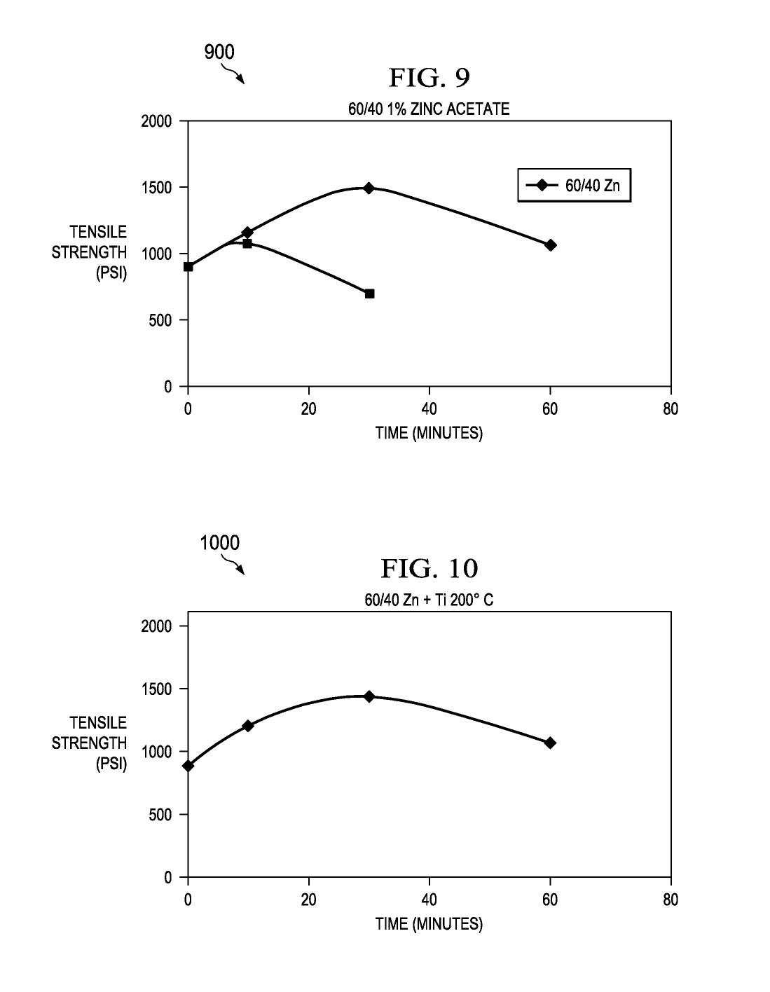

Melt compounded samples as prepared were hot-pressed into 6 in×6 in×0.05 in steel molds using a Tetrahedron Associates, Inc. programmable hot-press. The sheets were pressed at 260° F. at 9000 psi for 15 minutes. Manuel bumping cycles were applied to produce uniform void-free sheets. Dog bone shaped specimens were punched from the sheets using an ASTM D412 die punch and tested according to ASTM D412 testing standards. The results are shown in FIG. 7, table 700; FIG. 8, graph 800; FIG. 9, graph 900; and FIG. 10, graph 1000.

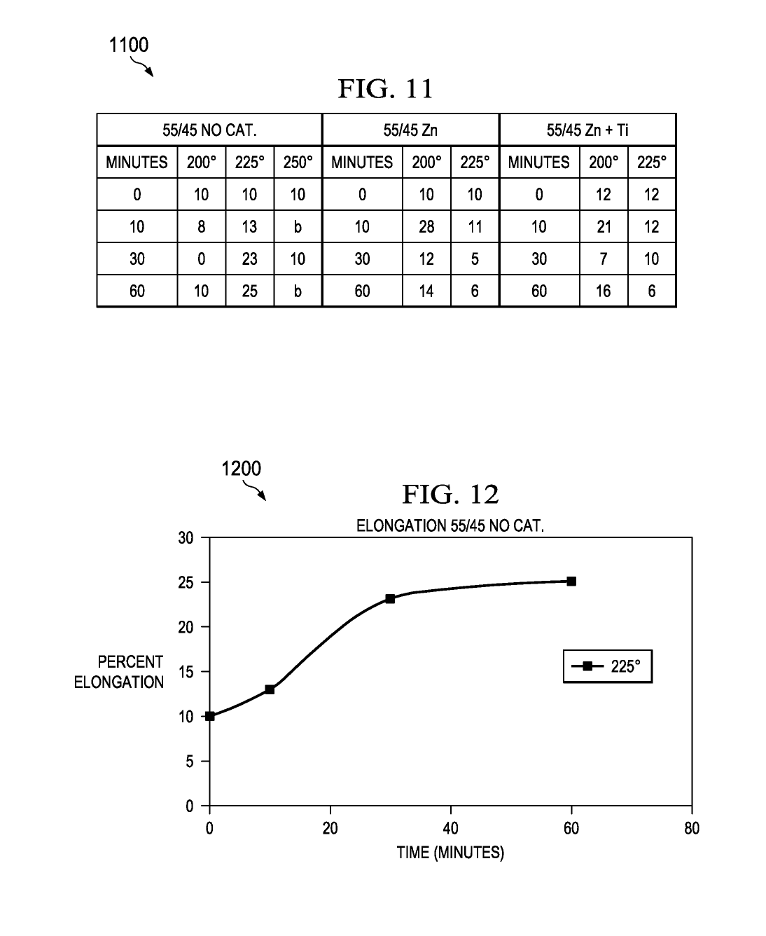

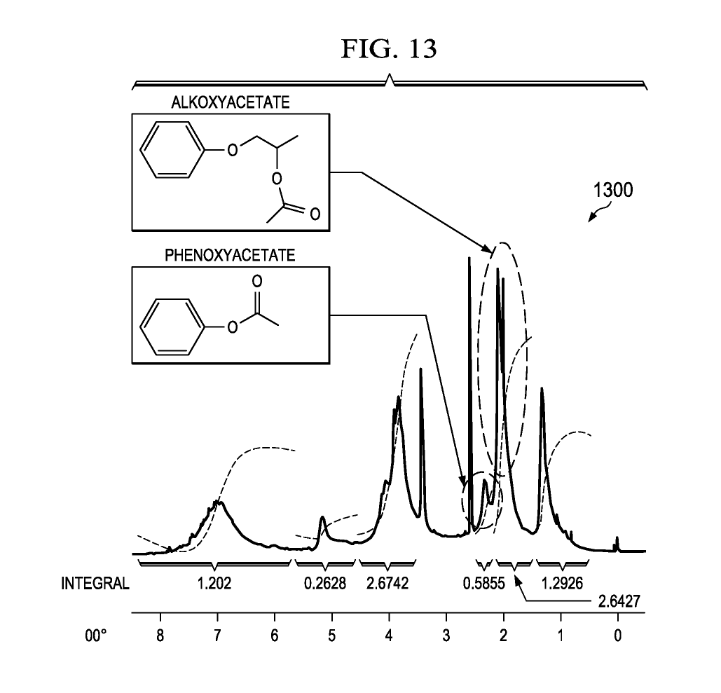

FIG. 11, table 1100 and FIG. 12, graph 1200 are a summary of some of the elongation (%) results according to ASTM D412. Samples were APL/PBAT blends composed of 55%, 60% and 70% APL. The conditions used to induce transesterification were heating at 200° C. 225° C. and 250° C. for 10, 30 and 60 minutes and with no catalyst, 1% zinc acetate catalyst, and a combination of 1% zinc acetate plus 1% titanium butoxide.

Each specimen was examined by DSC for changes in glass transition temperature (Tg) and melt endotherms. In addition each specimen (whether or not it too brittle for tensile testing) was examined by infrared to determine if there were any detectable changes in the chemical structure suggesting decomposition or other reactions. Tensile strength of the blends was slightly improved by extended heating and mixing in the range of 200° to 225° C. Generally, heating at 200° for 10 minutes was sufficient for maximal tensile improvement. Heating and mixing at 225° for more than 10 minutes and heating at 250° lead to increased embrittlement and decreased elongation-to-break. Addition of 1% sodium acetate catalyst or the addition of a combination of 1% sodium acetate and 1% titanium IV butoxide catalyst to the heating regime did not improve tensile strength beyond improvement observed from heating and mixing alone. No changes in Infrared spectra due to the transesterification conditions of the study were observed suggesting that no significant degree of chemical degradation or any other obvious changes in chemical functional groups had occurred.

Differential scanning calorimetry (DSC) demonstrated discrete glass transitions (Tg's) and melting endotherms (Tm's) for the modified lignin and polyester components of the blends, respectively. Since exposure to transesterification condition such thermal events did not result in merging or even in significant DSC changes, intimate mixing (as might be expected from increased compatibility of the lignin and polyester) were not observed.

### Example 1

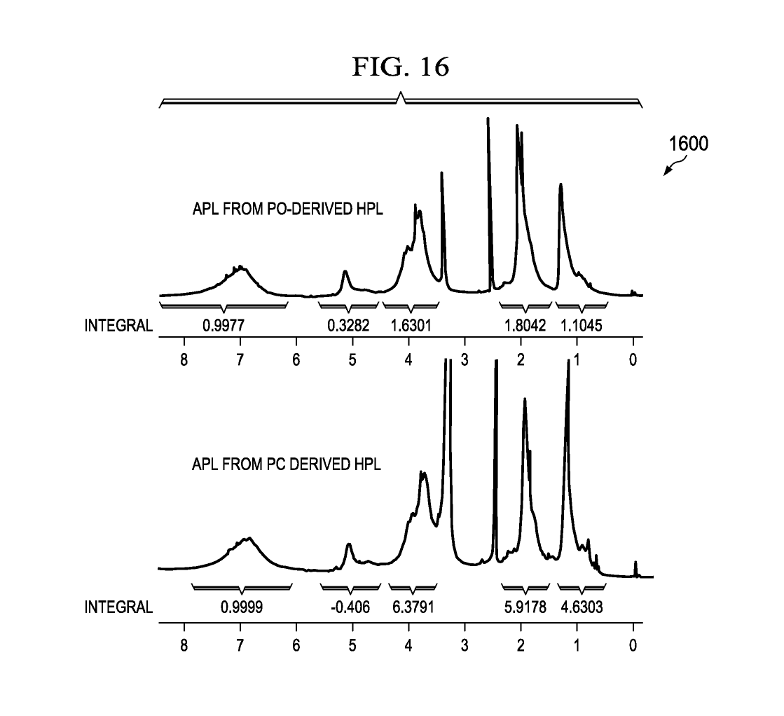

A lignin hydroxypropylation experiment was conducted using propylene carbonate as reactive solvent and 1-methylimidazole as a volatile base catalyst. Vacuum-oven-dried raw kraft lignin (750 g), propylene carbonate (500 g) and 1-methylimidazole (100 g) were combined and the mixture was heated to 160° C. for 5 hours in a high-torque mixer forming a viscous brown solution. The volatiles were removed by distillation under reduced pressure (2 in Hg, 160° C.) with the aid of a rotary-vane vacuum pump and an in-line solvent trap, to form a friable brown mass which was ground into a dark brown powder. Proton NMR (dmso d6, 300 MHz) of this product was identical with a proton NMR of HPL obtained by the propylene oxide route. The propylene carbonate HPL product was further characterized by preparing the corresponding acetylated derivative and this derivative was found, by proton NMR Illustrated in GRAPH 1600, FIG. 16, to be nearly identical to acetylated HPL obtained by the propylene oxide route, thus reconfirming that the desired product had been prepared.

### Example 2

A Ross and Sons® DPM-4 planetary mixer equipped with square blades and with a jacketed 4-gallon stainless steel mixing vessel was insulated with fiberglass batting and with reflecting foil insulation. One port of the reactor was modified with a Viton® rubber gasket to secure a water-cooled reflux condenser which was attached at its outlet to rubber tubing and a bubbler.

The jacketed vessel was then heated by means of a Julabo HE-4 heated/recirculating oil bath until the interior wall of the reactor vessel had reached 155° C. as measured by means of an integrated thermocouple thermometer. At that time, 300 g of propylene carbonate and 120 g of 1-methylimidazole were added through the second port and the rotation of the central shaft of the mixer was begun at 80 rpm. After the liquids had heated and stirred for about 5 minutes, 600 g of lignin powder (<5% moisture) were added in small portions through the second port over a period of about 10 minutes with rapid mixing. After the addition was complete, the second port was closed air-tight with a glass window and gaskets while vigorous stirring at 155° to 165° C. was continued for 1 hour. During this time a small amount of oily liquid was observed to reflux in the condenser as a vigorous evolution of gas (carbon dioxide) was observed passing through the bubbler. The exiting vapor and the oily liquid both were quite malodorous with a very strong smell of alkanethiols and/or other malodorous sulfur compounds. After 1 hour of heating and stirring at 155° to 165° C., the reaction vessel was rapidly cooled (over less than 25 minutes) to about 110° C., by switching the circulating oil in the jacket to another bath containing oil at ambient temperature and by external air cooling of the vessel with a fan.

The reaction vessel was opened and the viscous, molten, black contents were removed with a trowel and then added, with stirring, to a bucket containing 3 liters of water causing the formation of a light-brown precipitate. The pH of the suspension was adjusted to pH 3 by the slow addition of dilute sulfuric acid and afterward the mixture was stirred overnight. The precipitate was collected by suction filtration on a large table-top Buchner funnel followed by washing with copious amounts of water. After drying on the funnel, the product was dried in an oven at 60° C. for 24 hours to afford a light-brown powder HPL.

This HPL powder was melt-compound (blended) with EcoFlex® aliphatic/aromatic polyester (BASF Chemicals) in a ratio of 30% HPL to 70% Ecoflex® using a heated twin-screw extruder machine. The exiting blend was extruded through a die into the shape of a rod which was cooled in a water trough and pelletized. The pellets were dried of moisture and then were loaded into a hopper on a film-blowing extruder and then melted and blown into a continuous film (less than 0.5 mils in wall thickness) in the form of a tube. The film was judged to have a reduction in sulfurous malodors when compared with films blended from hydroxypropylated kraft lignin prepared by the propylene oxide route.

### Example 3

A Ross and Sons®, DPM-4 planetary mixer equipped with a jacketed 4-gallon stainless steel mixing vessel was insulated with fiberglass batting and with reflecting foil insulation. One port of the reactor cover was modified with a Viton® gasket to secure a water-cooled reflux condenser which was attached at its outlet to rubber tubing and a bubbler.

The jacketed vessel was then heated by means of a Julabo HE-4 heated/recirculating oil bath until the interior wall of the reactor vessel had reached 155° C. as m by means of an integrated thermocouple thermometer. At that time 300 g of propylene carbonate and 120 g of tri-n-butylamine were added through the second port and the rotation of the central shaft of the mixer was begun at 80 rpm. After the liquids had heated and stirred for about 5 minutes, 600 g of lignin powder (<5% moisture) were added in small portions through the second port over a period of about 10 minutes with rapid mixing. After the addition was complete, the second port was closed with an air-tight glass window and gaskets while vigorous stirring at 155° to 165° C. was continued for 1 hour. During this time a small amount of oily liquid was observed to reflux in the condenser as a vigorous evolution of gas (presumed to be carbon dioxide) was observed passing through the bubbler. The exiting vapor and the oily liquid both stank with a very strong odor of alkanethiols and/or other malodorous sulfur compounds. After 1 hour of heating and stirring at 155° to 165° C., the reaction vessel was rapidly cooled (over less than 25 minutes) to about 110° C., by switching the circulating jacket oil to another bath containing oil at ambient temperature and by external cooling of the vessel with a fan.

The reaction vessel was opened and the viscous, molten black contents were removed with a trowel to a PTFE-coated aluminum-foil pan and allowed to cool to a brittle black solid. The black solid was divided into 5 portions. One-at-a-time each portion was placed into an aluminum foil pan and then placed into a vacuum oven heated to 130° C. (Using high-temperature silicone-rubber sealant, a thin aluminum grill was attached to the inside of the glass oven door for the purpose of heating the glass window and thus reducing the condensation of volatiles on the glass door. Condensation on the door was further mitigated by irradiating the outside of the glass door with a heating lamp.) After a few minutes the contents of the pans in the vacuum oven had melted. At that time the volatiles were removed under reduced pressure of <1 mm Hg and were collected in a refrigerated condenser trap. The devolatilized product was then allowed to cool to a brown-black brittle solid which ground to a brown powder.

This HPL powder was melt-compound (blended) with EcoFlex® aliphatic/aromatic polyester (BASF Chemicals) in a ratio of 30% HPL to 70% Ecoflex in a heated extruder machine. The blend was extruded through a die as a rod which was cooled in a water trough and pelletized. The pellets were loaded into a hopper on a film-blowing extruder and melted and blown into a continuous film—a tube less than 0.5 mils in wall thickness. This film produced little or no sulfurous odor which was detectable to the human nose.

### Example 4

A Ross and Sons, DPM-4 planetary mixer with square blades and equipped with an evacuate-able jacketed 4-gallon stainless steel mixing vessel was insulated with fiberglass batting and reflecting foil insulation. The vacuum port of the reaction was connected to a refrigerated chiller condenser (trap) and further connected to a two-stage vacuum pump. The cover section of the reactor was wrapped with electrical-resistance heating tape secured with Kapton tape and then wrapped with fiberglass batting and silvered insulation. One port of the reactor was modified with a Viton rubber gasket to secure a water-cooled reflux condenser which was attached at its outlet to rubber tubing and a bubbler.

The jacketed vessel was then heated by means of a Julabo HE-4 heated/recirculating oil bath until the interior wall of the reactor vessel had reached 165° C. as determined by means of an integrated thermocouple thermometer. At that time 400 g of propylene carbonate and 200 g of tributylamine were added through the second port and the rotation of the central shaft of the mixer was begun at 80 rpm. After the liquids had heated and stirred for about 10 minutes the reactor temperature had returned to 160° C. and then 600 g of lignin powder (dried at 60° C. overnight in a Blue-M oven) were added in small portions through the second port over a period of about 10 minutes with rapid mixing. After the addition was complete, the second port was closed with an air-tight glass window and gaskets while vigorous stirring at 165° to 170° C. was continued for 1 hour. During this time a small amount of oily liquid was observed to reflux in the condenser as a vigorous evolution of gas (presumed to be carbon dioxide) was observed passing through the bubbler. The exiting vapor and the oily liquid both stank with a very strong odor of alkanethiols and/or other malodorous sulfur compounds. After 1 h of heating and stirring at 165° to 170° C., the reaction vessel was rapidly cooled (over less than 25 minutes) to about 110° C., by switching to another circulating bath containing oil at ambient temperature and by external air cooling of the vessel with a fan. At the same time the cover section of the reactor was heated to about 80° C. with electrical resistance heating. A valve connecting the reactor with the condenser and vacuum pump was opened and the reactor was evacuated to <1 mm Hg. After about 20 minutes the contents of the reactor had risen about 4 times in volume to produce a brown foam. At that time, heating was discontinued and the reactor was allowed to return to room temperature under vacuum, overnight.

The next day the brittle foam was broken into pieces and then ground into a brown powder HPL. A sample of the brown powder was dissolved in pyridine and acetylated with acetic anhydride with stirring at room temperature for 1 h. The mixture was poured into water and the resulting precipitate was washed thoroughly with water and then dried with suction and then in vacuo at 60° C. overnight. A sample was prepared by dissolving in deuterated dimethylsulfoxide (DMSO d6) and a ¹HNMR was acquired in 16 pulses on a Bruker 400 MHz NMR spectrometer. Examination of the integrated spectrum indicated that about 50% of the phenolic groups on the NMR sample were chemically modified into hydroxypropyl groups.

### Example 5

A 40 mm Coperion (W-P) intermeshing twin-screw extruder equipped with 12 barrels (50 L/D) was assembled with conveying and kneading screw elements. The temperature set-points for the extruder zones ranged from 50° C. (near the beginning) to 210° C. (near the end). The twin-screws were turned at the rate of 200 revolutions per minute. Tri-n-butylamine was pumped into the extruder at the rate of 3.75 pounds per hour and propylene carbonate was pumped into the extruder at the rate of 47 milliliters per minutes Dry powdered kraft lignin was then metered from a hopper into the feed-throat of the extruder at the rate of 25 pounds per hour. Viscous black material (80 pounds) exiting the extruder was collected in aluminum-foil pans and allowed to cool and solidify and then crushed and screened through a 5 mm sieve to afford solvent-wet HPL.

Then the extruder was reassembled to comprise three vacuum ports distributed along the extruder. The three vacuum ports were connect to a vacuum manifold comprising three corresponding regulatory valves. The manifold was, in-turn, connected to a series of vacuum pumps. The barrels of the extruder were heated to set-points ranging from 60° C. to 160° C. The crushed and sieved solvent-wet HPL of this example was then metered into the feed-throat of the extruder at the rate of 25 pounds per hour. After careful adjustments the three vacuum ports were stabilized at 27.9, 26.7 and 27.9 in Hg of vacuum (corrected to sea level, atm. press.=29.9 in Hg). After extruding material under these conditions for 30 minutes the collected devolatilized product was found to have less than 0.2% residual volatiles as determination from the loss-in-weight of analytical samples further dried in a vacuum oven (130° C., at <1 mm Hg vacuum) for extended periods of time.

### Example 6

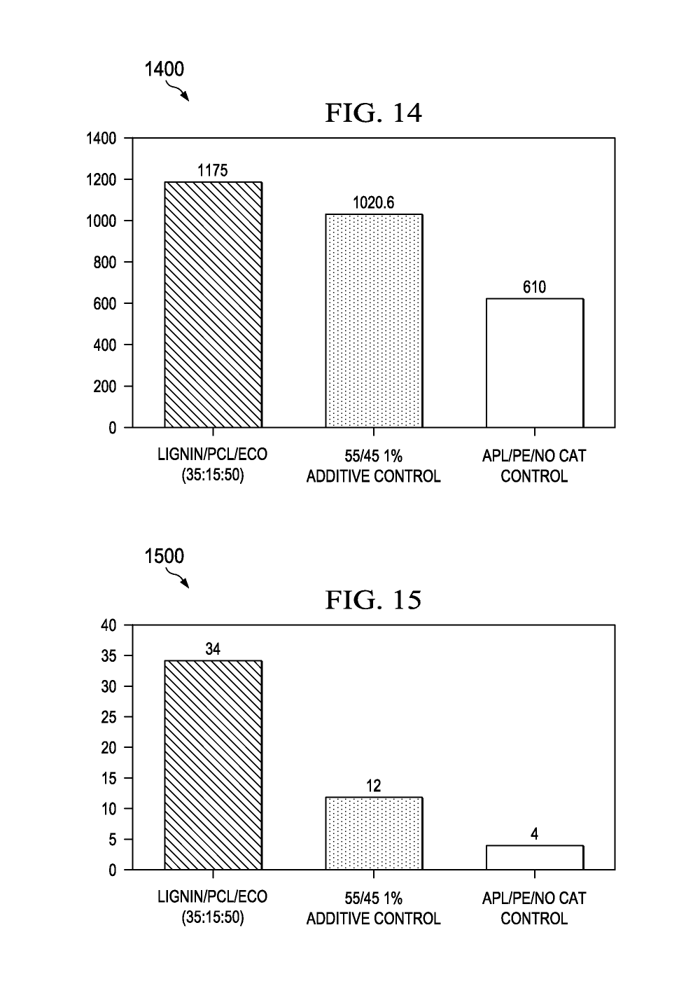

In a specific example, a lignin was chemically modified with polyester oligomers using an in situ, solvent-free esterification reaction using caprolactone and as-received Kraft lignin to afford a polycaprolactone-derivatized lignin. Kraft lignin can be reacted with caprolactone at 130° using a few drops of dibutyltin dilaurate as catalyst. In one experiment, lignin and caprolactone were reacted in a ratio of 2:1 (wt:wt) for 48 hours in a high-sheer mixer to afford a black power. Subsequently the black powder was blended in ratio of 1:1 with PBAT. The blended material was formed into a 6″×6″×0.05″ dimensions in a heated press to afford a very flexible black sheet. The tensile strength and elongation to break of the sheet were determined. At an average of 1175 psi the PCL-modified lignin/PBAT blend tensile strength was comparable or better than similar the HPL/PBAT specimens containing approximately the same proportion of PBAT (50% for the former compared with 55% for the later). Most notably, the tensile elongation (averaging 35%) for the PCL-modified lignin/PBAT sheet was superior to any of the HPL/Ecoflex blend. The two specimens punched near the center of the sheet (specimens 2 and 3) the tensile strength was higher (around 1300 psi) and the tensile elongation averaged 57.5%. The PCL Lignin/PBAT blend and HPL/PBAT blends are compared graphically in FIG. 14, graph 1400 illustrating tensile strength and FIG. 15, graph 1500 illustrating tensile elongation.

### Example 7

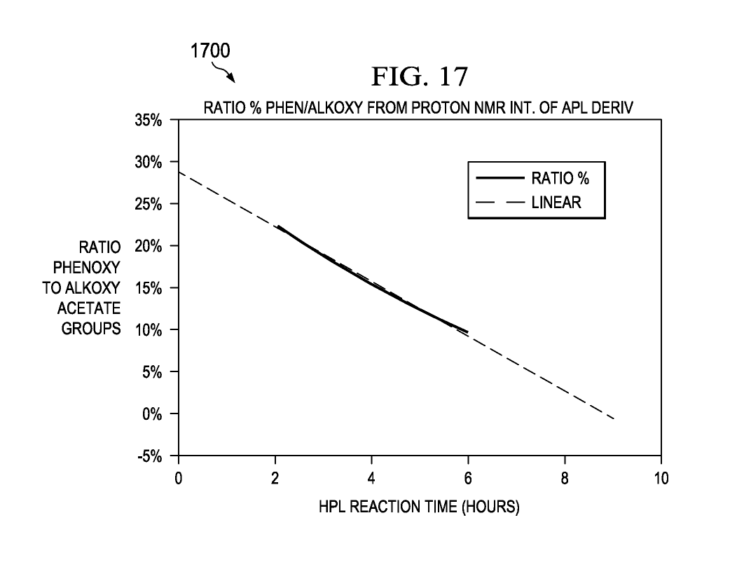

In another specific example, for an HPL reaction, small aliquots of the reaction mixture were removed after 2, 4, 5, and 6 hours of reaction time and worked up. Samples of the acetoxypropyl lignin (APL) derivatized HPL were examined by proton NMR, as illustrated in FIG. 13, graph 1300. The integration of the broad signals at about 2.3 ppm (phenoxyacetate CH3) and at about 1.8 ppm (acetoxy CH3) and ratio of the integrated peaks were plotted against reaction time as shown in FIG. 17, graph 1700. The results indicate that hydroxyl propylation of all the phenols on lignin would be complete or virtually complete after about 9 hours.

### Example 8

In yet another experiment, the processing of lignin-thermoplastic compositions by blown film extrusion was realized. Various blends of HPL and Ecoflex as well as blends of acylated HPL, APL, and PBAT polyester were melt compounded, pelletized, dried, and then introduced into a blown film extrusion apparatus. It was found that compositions up to 40% HPL lignin in PBAT could be extruded into blown films which were homogeneous and demonstrated tensile strength comparable to common thermoplastic used in blown film extrusion. APL/PBAT blends could also be blown film extruded but were less homogenous and contained defects.

### Example 9

In another example, transesterification experiments of 55%/45% Blends of APL with PBAT were conducted as follows: Mixtures of APL powder (55%, 60%, and 70% by weight) with PBAT pellets (45%, 40%, and 30% blending in a high shear mixer at 130° C. for 15 minutes at about 75 rpm mixing speed and then each batch was removed from the mixer and allowed to cool.

### Example 11

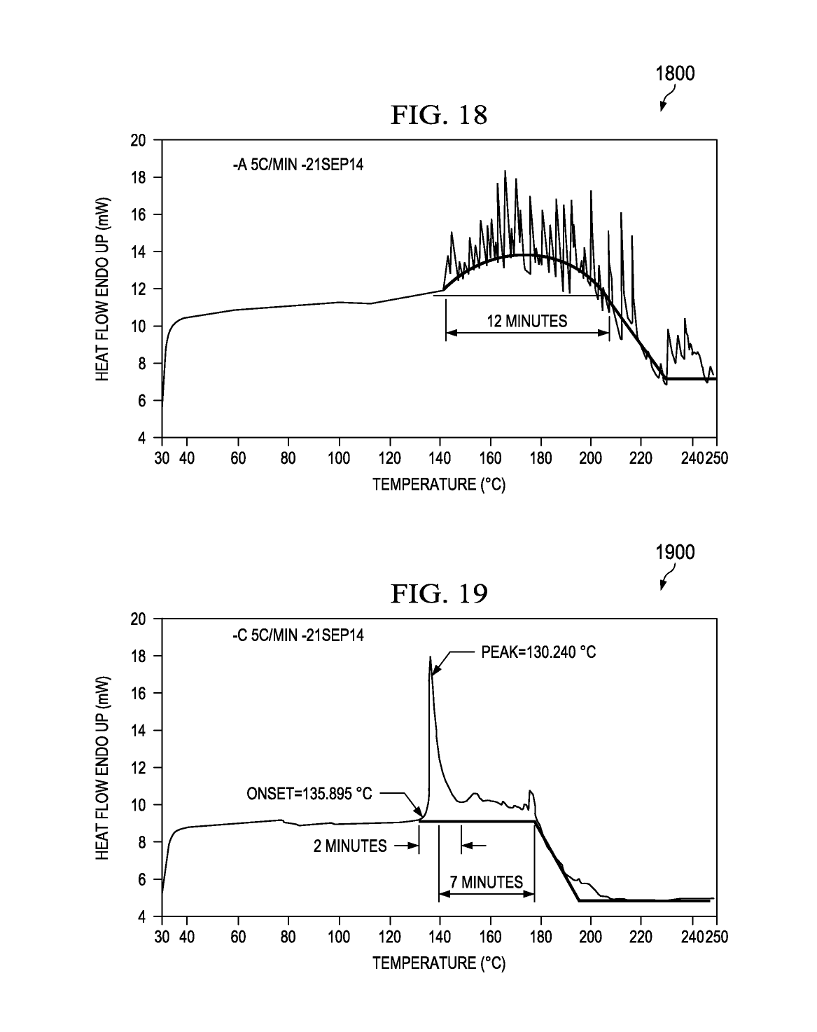

Kraft lignin (2 g), propylene carbonate (1 g) and tributylamine (0.3 g) were combined in a ceramic mortar and pestle and thoroughly mixed for about one minute at room temperature to form a paste. A sample of this mixture was sealed in an aluminum differential scanning calorimeter (DSC) pan which had been pierced with a pin-hole. The prepared sample was heated at a rate of 5 deg. per minute from 30° C. to 250° C. using a Perkin Elmer Pyris 6 thermogravimetric analyzer (TGA)/differential scanning calorimeter (DSC) instrument. The DSC analysis was repeated several times with fresh samples of this mixture and was found to reproduce nearly identical thermograms upon each analysis. An examination of the resulting DSC thermogram illustrated in FIG. 18, graph 1800, evidenced an endothermic reaction appearing as a broad endothermic peak, with an onset at about 140° C., a maximum at about 175° C., and, at about 210° C., a drop in the trace below the original baseline (extrapolated) to a new, lower baseline. The change of baseline level suggests a lowering of the heat capacity of the sample due to loss of sample mass such as would result from the loss of carbon dioxide from the expected reaction. The numerous random spikey peaks superimposed on the endotherm curve are likely due to sputtering of carbon dioxide gas through the pin hole in the pan. The width of the endotherm suggests a reaction lasting about 12 minutes

### Example 12

Kraft lignin (2 g), propylene carbonate (1 g) and 1-methylimidazole (0.3 g) were combined in a ceramic mortar and pestle and thoroughly mixed for about one minute at room temperature to produce a paste. A sample of this mixture was sealed in an aluminum differential scanning calorimeter (DSC) pan which had been pierced with a pin-hole. The prepared sample was heated at a rate of 5 deg. per minute from 30° C. to 250° C. using a Perkin Elmer Pyris 6 thermogravimetric analyzer (TGA)/differential scanning calorimeter (DSC) instrument. The DSC analysis was repeated several times with fresh samples of this mixture and was found to reproduce nearly identical thermograms upon each repetition of the analysis. An examination of the resulting DSC thermogram illustrated in FIG. 19, graph 1900, suggests an endothermic reaction appearing as a broad endothermic peak, with an onset at 135.9° C., overlaid with a sharp-peak feature appearing near the onset (maximum at 136.2° C.). At the end of the endotherm, at about 180° C., the curve drops below the original baseline (extrapolated) to a new, lower baseline. The change of baseline level suggests a lowering of the heat capacity of the sample due to loss of sample mass such as would result from the loss of carbon dioxide due to a chemical reaction. The width of the endotherm suggests a total reaction lasting about 7 minutes

### Example 13

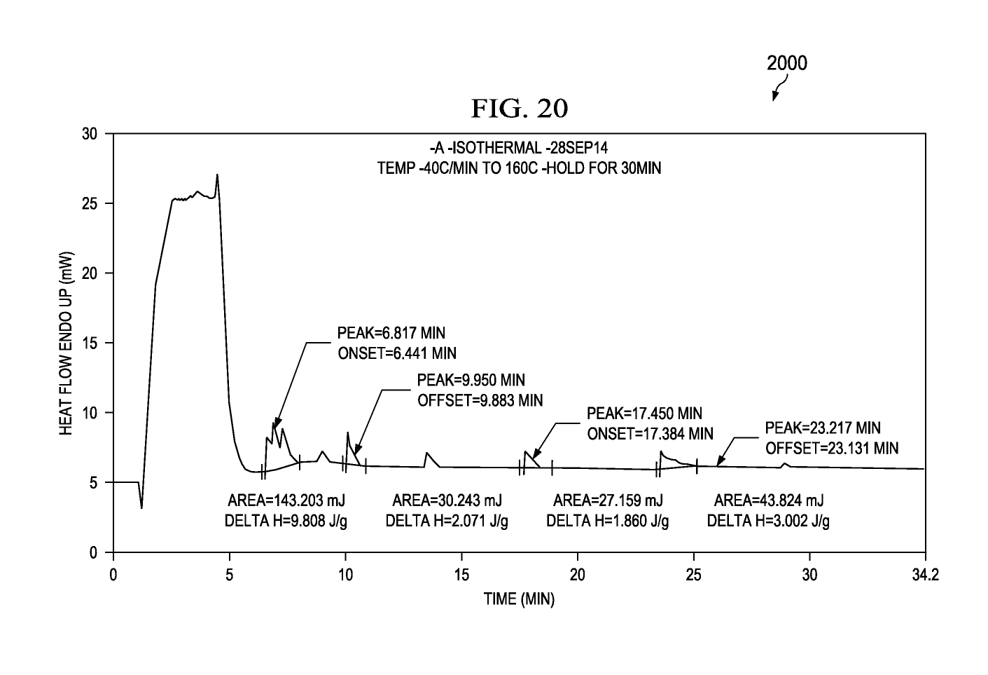

Kraft lignin (2 g), propylene carbonate (1 g) and tributylamine (0.3 g) were combined in a ceramic mortar and pestle and thoroughly mixed about one minute at room temperature to produce paste. A sample of this mixture was sealed in an aluminum differential scanning calorimeter (DSC) pan which had been pierced with a pin-hole. Using a Perkin Elmer Pyris 6 thermogravimetric analyzer (TGA)/differential scanning calorimeter (DSC) instrument, the prepared sample was heated at 40° C. per minute from 30° C. to 160° C. and then held for 30 minutes at 160° C. The resulting thermogram illustrated in FIG. 20, graph 2000, indicated that the reaction is rapid upon ramping past about 140° C. and essentially complete in about 2.5 minutes in the temperature ramp from 140° C. to 160° C.

### Example 14

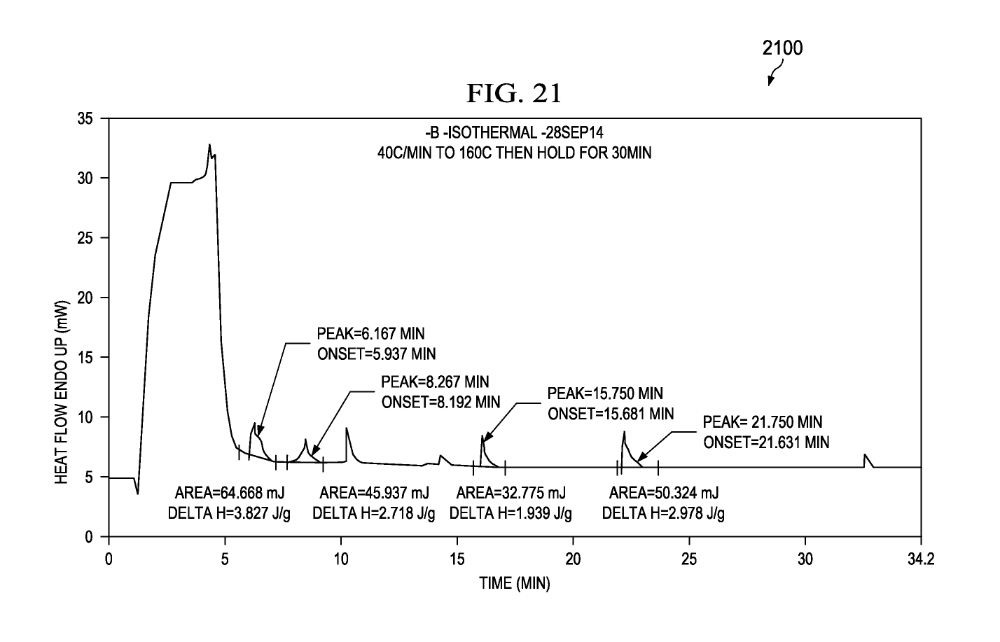

Kraft lignin (2 g), propylene carbonate (1 g) and tributylamine (1.0 g) were combined in a ceramic mortar and pestle and thoroughly mulled for about one minute at room temperature. A sample of this mixture was sealed in an aluminum differential scanning calorimeter (DSC) pan which had been pierced with a pin-hole. Using a Perkin Elmer Pyris 6 thermogravimetric analyzer (TGA)/differential scanning calorimeter (DSC) instrument the prepared sample was heated at 40° C. per minute from 30° C. to 160° C. and then held for 30 minutes at 160° C. The resulting thermogram illustrated in FIG. 21, graph 2100, indicated that the reaction is rapid upon ramping past about 140° C. and essentially complete in about 2.5 minutes in the temperature ramp from 140° C. to 160° C. The increase of the tributylamine from 0.3 g in the previous example to 1.0 g in the present example appeared to have little effect on the reaction rate.

### Example 15

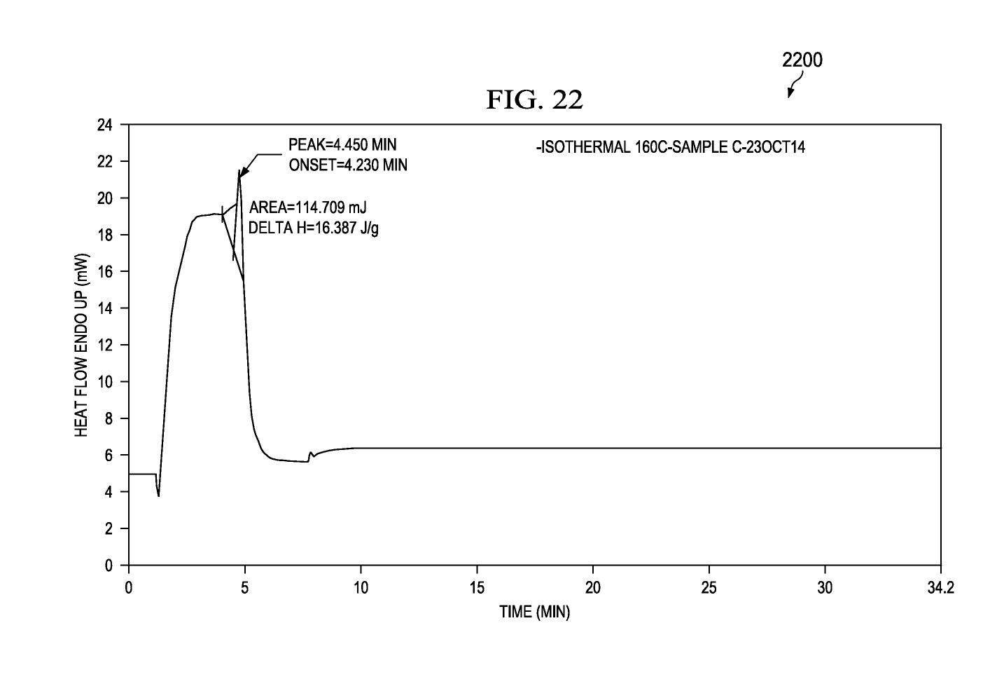

Kraft lignin (2 g), propylene carbonate (1 g) and 1-methylimidazole (0.3 g) were combined in a ceramic mortar and pestle and thoroughly mixed for about one minute at room temperature to form a paste. A sample of this mixture was sealed in an aluminum differential scanning calorimeter (DSC) pan which had been pierced with a pin-hole. Using a Perkin Elmer Pyris 6 thermogravimetric analyzer (TGA)/differential scanning calorimeter (DSC) instrument the prepared sample was heated at 40° C. per minute from 30° C. to 160° C. and then held for 30 minutes at 160° C. The resulting thermogram illustrated in FIG. 22, graph 2200, indicated that the reaction is rapid upon ramping past about 140° C. and essentially complete in about 2.5 minutes in the temperature ramp from 140° C. to 160° C.

### Example 16

A 40 mm Coperion® (W-P) intermeshing twin-screw extruder equipped with 12 barrels (50 L/D) was assembled with conveying and kneading screw elements. The temperature set-points for the extruder zones ranged from 50° C. (near the beginning) to 210° C. (near the end). The twin-screws were turned at the rate of 200 revolutions per minute. Tri-n-butylamine was pumped into the extruder at the rate of 5.29 pounds per hour and propylene carbonate was pumped into the extruder at the rate of 44.3 milliliters per minute. Dry powdered kraft lignin was then metered from a hopper into the feed-throat of the extruder at the rate of 35 pounds per hour. Viscous black material exiting the extruder was collected in aluminum-foil pans and allowed to cool and solidify and then ground to afford solvent-wet HPL as a brown powder.

A portion of the solvent-wet HPL (about 5 pounds) was placed in a large, deep aluminum-foil pan and then was placed in a Ross and Sons, DPM-4 planetary mixer equipped with an evacuate-able jacketed 4-gallon stainless steel mixing vessel insulated with fiberglass batting and with reflecting foil insulation. (The stirring blades were removed.) The vacuum port of the reaction was connected to a refrigerated chiller condenser (trap) and further connected to a two-stage vacuum pump. The cover section of the reactor was wrapped with electrical-resistance heating tape secured with Kapton® tape and then wrapped with fiberglass batting and with silvered insulation.

By means of circulating hot oil in the jacket, the reaction vessel was heated to 130° C. At the same time the cover section of the reactor was heated to about 80° C. with electrical resistance heating. After about 1 hour of heating the contents of the reactor were observed to have become molten. Then a valve connecting the reactor with the condenser and vacuum pump was opened and the reactor was evacuated to <1 mm Hg. After about 30 minutes the contents of the reactor had risen about 4 times in volume to produce a brown foam. The reactor was opened and upon cooling the brown foam was ground to a brown powder.

This HPL powder was melt-compound (blended) with EcoFlex® aliphatic/aromatic polyester (BASF Chemicals) in a ratio of 30% HPL to 70% Ecoflex® using a heated twin-screw extruder machine. The exiting blend was extruded through a die into a rod which was cooled in a water trough and pelletized. The pellets were dried of moisture and then were loaded into a hopper on a film-blowing extruder and then melted and blown into a continuous film (less than 0.5 mils in wall thickness) in the form of a tube. This film produced virtually no sulfurous odor or a relatively minor sulfurous odor.

Note that many of the compositions, materials, percentages, etc. discussed herein could readily be changed, modified, altered, or substituted with different materials without departing from the teachings of the present disclosure. It is similarly imperative to note that the operations and steps described with reference to the preceding FIGURES illustrate only some of the possible scenarios that may be executed by, or within, the systems of the present disclosure. Some of these operations may be deleted or removed where appropriate, or these steps may be modified or changed considerably without departing from the scope of the discussed concepts. In addition, the timing of these operations may be altered considerably and still achieve the results taught in this disclosure. The preceding discussions have been offered for purposes of example and discussion. Substantial flexibility is provided by the system in that any suitable arrangements, chronologies, configurations, and timing mechanisms may be provided without departing from the teachings of the discussed concepts. Along similar lines, the ranges (e.g., with respect to timing, temperature, concentrations, etc.) could be varied considerably without departing from the scope of the present disclosure.

Note that with the examples provided above, interaction may be described in terms of two, three, or four elements. However, this has been done for purposes of clarity and example only. In certain cases, it may be easier to describe one or more of the functionalities of a given set of flows by only referencing a limited number of elements. It should be appreciated that the examples described (and their teachings) are readily scalable and, further, can accommodate a large number of components, as well as more complicated/sophisticated arrangements and configurations. Accordingly, the examples provided should not limit the scope or inhibit the broad teachings as potentially applied to a myriad of other architectures.

It is also important to note that the steps in the preceding flows illustrate only some of the possible scenarios that may be executed or preformed. Some of these steps may be deleted or removed where appropriate, or these steps may be modified or changed considerably without departing from the scope of the present disclosure. In addition, a number of these operations may have been described as being executed concurrently with, or in parallel to, one or more additional operations. However, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example M1 is a method including combining lignin, cyclic alkene carbonate, and a basic/alkaline compound and allowing the cyclic alkene carbonate and the basic/alkaline compound to modify the lignin to produce a hydroxyalkoxylated lignin.

In Example M2, the subject matter of Example M1 can optionally include where the cyclic alkene carbonate acts as a hydroxyalkoxylating reagent and the basic/alkaline compound acts as a catalyst.

In Example M3, the subject matter of any one of Examples M1-M2 can optionally include where the lignin is modified in a non-aqueous reaction media.

In Example M4, the subject matter of any one of Examples M1-M3 can optionally include where the basic/alkaline compound includes an aliphatic, heterocyclic or aromatic amine having a pKa dissociation constant in the range of about 9 to about 13.

In Example M5, the subject matter of any one of Examples M1-M4 can optionally include where the lignin, the cyclic alkene carbonate, and the basic/alkaline compound are combined in a continuous or semi-continuous reaction process or a one-pot reaction.

In Example M6, the subject matter of any one of Examples M1-M5 can optionally include where the continuous or semi-continuous reaction process is a continuous reactive extrusion process.

In Example M7, the subject matter of any one of Examples M1-M6 can optionally include where the cyclic alkene carbonate and the basic/alkaline compound are not readily volatile at reaction temperatures but can be evaporated during the continuous reactive extrusion process.

Example M1-A is a method including combining lignin, a dialkyl carbonate, and a basic/alkaline compound and allowing the dialkyl carbonate and the basic/alkaline compound to modify the lignin to produce an alkoxylate-modified lignin.

In Example M2-A, the subject matter of Example M1-A can optionally include where the dialkyl carbonate acts as an alkoxylating reagent and the basic/alkaline compound acts as a catalyst.

In Example M3-A, the subject matter of any one of Examples M1-A-M2-A can optionally include where the lignin is modified in a non-aqueous reaction media.

In Example M4-A, the subject matter of any one of Examples M1-A-M3-A can optionally include where the basic/alkaline compound includes an aliphatic, heterocyclic or aromatic amine having a pKa dissociation constant in the range of about 9 to about 13.

In Example M5-A, the subject matter of any one of Examples M1-A-M4-A can optionally include where the lignin, the dialkyl carbonate, and the basic/alkaline compound are combined in a continuous or semi-continuous reaction process or a one-pot reaction.

In Example M6-A, the subject matter of any one of Examples M1-A-M5-A can optionally include where the continuous or semi-continuous reaction process is a continuous reactive extrusion process.

In Example M7-A, the subject matter of any one of Examples M1-A-M6-A can optionally include where the dialkyl carbonate and the basic/alkaline compound are not readily volatile at reaction temperatures but can be evaporated during the continuous reactive extrusion process.

Example M1-B includes a method for producing a hydroxyalkoxylated lignin using a reactive solvent as a lignin-chemically-modifying reagent, where the reactive solvent dissolves un-fractionated kraft lignin at a concentration greater than about thirty percent solids at about 100° C. to produce the hydroxyalkoxylated lignin.

In Example M2-B, the subject matter of Example M1-B can optionally include where the reactive solvent is propylene carbonate.

In Example M3-C, the subject matter of any one of Examples M1-B-M2-B can optionally include where the reactive solvent is an alkene carbonate or an alkyl carbonate.

In Example M4-B, the subject matter of any one of Examples M1-B-M4-B can optionally include where the hydroxyalkoxylated lignin is produced in a non-aqueous reaction media.

In Example M5-B, the subject matter of any one of Examples M1-B-M5-B can optionally include where the hydroxyalkoxylated lignin is produced in a continuous or semi-continuous reaction process or a one-pot process.

In Example M6-B, the subject matter of any one of Examples M1-B-M6-B can optionally include where the hydroxyalkoxylated lignin is produced in a reactive extrusion process.

Example M1-C includes a method for manufacturing a hydroxyalkoxylate-modified lignin using a cyclic alkene carbonate as a hydroxyalkoxylating reagent in the presence of a basic/alkaline compound (catalyst).

In Example M2-C, the subject matter of Example M1-C can optionally include where the basic/alkaline compound includes an aliphatic, heterocyclic or aromatic amine having a pKa dissociation constant in the range of 9 to 13.

In Example M3-C, the subject matter of any one of Examples M1-C-M2-C can optionally include where the basic amine is a tertiary amine.

In Example M4-C, the subject matter of any one of Examples M1-C-M3-C can optionally include where the basic amine has boiling point greater than 150° C. but less than 350° C. when measured at 760 mm Hg of pressure.

In Example M5-C, the subject matter of any one of Examples M1-C-M4-C can optionally include where the basic amine has a dielectric constant in the range of 2 to 10.

In Example M6-C, the subject matter of any one of Examples M1-C-M5-C can optionally include where the basic amine is a liquid immiscible with propylene carbonate.

In Example M7-C, the subject matter of any one of Examples M1-C-M6-C can optionally include where the basic amine comprises a sterically-hindered basic nitrogen.

In Example M8-C, the subject matter of any one of Examples M1-C-M7-C can optionally include where the basic amine is has the formula R1-N(R2)-R3, where R1,R2 and R3 are each chosen from straight or branched hydrocarbon chains having 1 to 10 carbon atoms.

In Example M9-C, the subject matter of any one of Examples M1-C-M8-C can optionally include where the basic amine is tri-n-butylamine.

In Example M10-C, the subject matter of any one of Examples M1-C-M9-C can optionally include where the method is conducted as a “one-pot” process whereby the cyclic alkene carbonate reagent reacts with lignin in the presence of the basic compound within a vessel and subsequently the alkylcarbonate reagent and the basic compound (catalyst) are removed as volatiles, leaving the hydroxyalkoxylate-modified lignin as a dry or nearly-dry solid or molten residue.

In Example M11-C, the subject matter of any one of Examples M1-C-M10-C can optionally include where the method is conducted as an efficient continuous or semi-continuous process whereby near the beginning of the process the cyclic alkene carbonate reagent reacts with lignin in the presence of the basic compound and then at a later point in the continuous or semi-continuous process the cyclic alkene carbonate reagent and the basic compound (catalyst) are removed as volatiles, leaving the hydroxyalkoxylate-modified lignin as a dry or nearly-dry solid or molten residue. The continuous or semi-continuous process to employ one or more machines including a stirred vessel, a pumping and piping system, a screw conveyer (extruder) employing a single or multiple screws either intermeshing or non-intermeshing or co-rotating or counter rotating, or other chemical processing equipment.

In Example M12-C, the subject matter of any one of Examples M1-C-M11-C can optionally include where the method is conducted in a reactive extruder machine, or in two or more reactive extruder machines, connected in tandem or in a series, whereby near the beginning of the process the cyclic alkene carbonate reagent reacts with lignin in the presence of the basic compound (catalyst) and then at a later point in the reactive extrusion process the excess cyclic alkene carbonate reagent and the basic compound (catalyst) are removed as volatiles, leaving the hydroxyalkoxylate-modified lignin as a dry or nearly-dry solid.

Example M1-D includes a method for manufacturing a hydroxypropoxylate-modified lignin using propylene carbonate as hydroxypropoxylating reagent in the presence of a basic/alkaline compound

In Example M2-D, the subject matter of Example M1-D can optionally include where the basic/alkaline compound is comprises an aliphatic, heterocyclic or aromatic amine having a pKa dissociation constant in the range of 9 to 13.

In Example M3-D, the subject matter of any one of Examples M1-D-M2-D can optionally include where the basic amine is a tertiary amine.

In Example M4-D, the subject matter of any one of Examples M1-D-M3-D can optionally include where the basic amine has boiling point greater than 150° C. but less than 350° C. when measured at 760 mm Hg or pressure.

In Example M5-D, the subject matter of any one of Examples M1-D-M4-D can optionally include where the basic amine has a dielectric constant in the range of 2 to 10.

In Example M6-D, the subject matter of any one of Examples M1-D-M5-D can optionally include where the basic amine is a liquid immiscible with propylene carbonate.

In Example M7-D, the subject matter of any one of Examples M1-D-M6-D can optionally include where the basic amine comprises a sterically-hindered basic nitrogen.

In Example M8-D, the subject matter of any one of Examples M1-D-M7-D can optionally include where the basic amine is has the formula R1-N(R2)-R3, where R1,R2 and R3 are each chosen from straight or branched hydrocarbon chains having 1 to 10 carbon atoms.

In Example M9-D, the subject matter of any one of Examples M1-D-M8-D can optionally include where the basic amine is tri-n-butylamine.

In Example M10-D, the subject matter of any one of Examples M1-D-M9-D can optionally include where the method can be conducted as an efficient “one-pot” process whereby the propylene carbonate reagent reacts with lignin in the presence of the basic compound within a vessel and subsequently the excess propylene carbonate reagent and the basic compound (catalyst) are removed as volatiles, employing the same vessel or another vessel, leaving the hydroxypropoxylate-modified lignin as a dry or nearly-dry solid or molten residue.

In Example M11-D, the subject matter of any one of Examples M1-D-M10-D can optionally include where the method can be conducted as an efficient continuous or semi-continuous process whereby near the beginning of the process the propylene carbonate reagent reacts with lignin in the presence of the basic compound and then at a later point in the continuous or semi-continuous process the propylene carbonate reagent and the basic compound (catalyst) are removed as volatiles, leaving the hydroxypropoxylate-modified lignin as a dry or nearly-dry solid or molten residue; the continuous or semi-continuous process to employ one or more machines including a stirred vessel, a pumping and piping system, a screw conveyer (extruder) employing a single or multiple screws either intermeshing or non-intermeshing or co-rotating or counter rotating, or other chemical processing equipment.

In Example M12-D, the subject matter of any one of Examples M1-D-M11-D can optionally include where the method can be conducted in a reactive extruder machine, or in two or more reactive extruder machines, connected in tandem or in a series, whereby near the beginning of the process the propylene carbonate reagent reacts with lignin in the presence of the basic compound (catalyst) and then at a later point in the reactive extrusion process the propylene carbonate reagent and the basic compound (catalyst) are removed as volatiles, leaving the hydroxypropoxylate-modified as a dry or nearly-dry solid.

Example M1-E includes a method for removing malodorous compounds and for mitigating sulfurous odors inherent in lignin, lignin derivatives and lignin products and especially for mitigating odors inherent in lignin materials derived from kraft pulping processes, whereby lignin is dissolved or suspended in propylene carbonate or a mixture of propylene carbonate and an amine and heated to a temperature in the range of about 75° C. to about 300° C., with or without stirring, for a period of about 0.5 minutes to about 12 hours.

In Example M2-E, the subject matter of Example M1-E can optionally include where the propylene carbonate and or the amine are subsequently removed under reduced pressure of about 40 mm Hg or less with or without heating.

Example M1-F includes a method where a hydroxypropylated lignin or another chemically-modified lignin is prepared simultaneously with the removal or mitigation of sulfurous and/or other malodorous compounds whereby lignin is dissolved in a mixture of propylene carbonate and an amine and heated to a temperature in the range of about 75° C. to about 300° C., with or without stirring, for a period of about 0.5 minutes to about 12 hours.

In Example M2-F, the subject matter of Example M1-F can optionally include where the propylene carbonate and or the amine are subsequently removed under reduced pressure of about 40 mm Hg or less with or without heating.

Example M1-G includes a method for manufacturing an alkoxylate-modified lignin using a dialkyl carbonate as an alkoxylating reagent in the presence of a basic/alkaline compound (catalyst).

In Example M2-G, the subject matter of Example M1-G can optionally include where the basic/alkaline compound is comprises an aliphatic, heterocyclic or aromatic amine having a pKa dissociation constant in the range of about 9 to about 13.

In Example M3-G, the subject matter of any one of Examples M1-G-M2-G can optionally include where the basic amine is a tertiary amine.

In Example M4-G, the subject matter of any one of Examples M1-G-M3-G can optionally include where the basic amine has boiling point greater than 150° C. but less than 350° C. when measured at 760 mm Hg or pressure.

In Example M5-G, the subject matter of any one of Examples M1-G-M4-G can optionally include where the basic amine has a dielectric constant in the range of 2 to 10.

In Example M6-G, the subject matter of any one of Examples M1-G-M5-G can optionally include where the basic amine is a liquid immiscible with propylene carbonate.

In Example M7-G, the subject matter of any one of Examples M1-G-M6-G can optionally include where the basic amine comprises a sterically-hindered basic nitrogen.

In Example M8-G, the subject matter of any one of Examples M1-G-M7-G can optionally include where the basic amine is has the formula R1-N(R2)-R3, where R1, R2 and R3 are each chosen from straight or branched hydrocarbon chains having 1 to 10 carbon atoms.

In Example M9-G, the subject matter of any one of Examples M1-G-M8-G can optionally include where the basic amine is tri-n-butylamine.

In Example M10-G, the subject matter of any one of Examples M1-G-M9-G can optionally include where the method can be conducted as a “one-pot” process whereby the dialkylcarbonate reagent reacts with lignin in the presence of the basic compound within a vessel and subsequently the dialkylcarbonate reagent and the basic compound (catalyst) are removed as volatiles, employing the same vessel or another vessel, leaving the alkoxylate-modified lignin as a dry or nearly-dry solid or a molten residue.

In Example M11-G, the subject matter of any one of Examples M1-G-M10-G can optionally include where the method can be conducted as a continuous or semi-continuous process whereby near the beginning of the process the dialkylcarbonate reagent reacts with lignin in the presence of the basic compound and then at a later point in the continuous or semi-continuous process the dialkylcarbonate reagent and the basic compound (catalyst) are removed as volatiles, leaving the alkoxylate-modified lignin as a dry or nearly-dry solid or molten residue; the continuous or semi-continuous process to employ one or more machines such as a stirred vessel, a pumping and piping system, a screw conveyer (extruder) employing a single or multiple screws either intermeshing or non-intermeshing or co-rotating or counter rotating, or other chemical processing equipment.

In Example M12-G, the subject matter of any one of Examples M1-G-M11-G can optionally include where the method can be conducted in a reactive extruder machine, or in two or more reactive extruder machines, connected in tandem or in a series, where near the beginning of the process the dialkylcarbonate reagent reacts with lignin in the presence of the basic compound (catalyst) and then at a later point in the reactive extrusion process the dialkylcarbonate reagent and the basic compound (catalyst) are removed as volatiles, leaving the alkoxylate-modified lignin as a dry or nearly-dry solid or molten residue.

Example M1-H includes a method for preparing polycaprolactone-grafted lignin, where a gamma-caprolactone reagent is polymerized in situ and grafted to lignin in the presence of lignin and a suitable catalyst.

In Example M2-H, the subject matter of Example M1-H can optionally include where the polycaprolactone-grafted lignin is prepared by reactive extrusion.

Example M1-I includes a method for preparing polycaprolactone-grafted lignin, whereby gamma-caprolactone reagent is polymerized in situ and grafted to lignin in the presence of lignin and a suitable catalyst and in the absence of added solvent.

In Example M2-I, the subject matter of Example M1-I can optionally include where the polycaprolactone-grafted lignin is prepared by reactive extrusion.

What is claimed is:

1. A method comprising:
combining lignin, cyclic alkene carbonate, and a basic/alkaline compound; and
allowing the cyclic alkene carbonate and the basic/alkaline compound to modify the lignin to produce a hydroxyalkoxylated lignin.

2. The method of claim 1, wherein the cyclic alkene carbonate acts as a hydroxyalkoxylating reagent and the basic/alkaline compound acts as a catalyst.

3. The method of claim 1, wherein the lignin is modified in a non-aqueous reaction media.

4. The method of claim 1, wherein the basic/alkaline compound includes an aliphatic, heterocyclic or aromatic amine having a pKa dissociation constant in the range of about 9 to about 13.

5. The method of claim 1, wherein the lignin, the cyclic alkene carbonate, and the basic/alkaline compound are combined in a continuous or semi-continuous reaction process.

6. The method of claim 5, wherein the continuous or semi-continuous reaction process is a continuous reactive extrusion process.

7. The method of claim 6, wherein the cyclic alkene carbonate and the basic/alkaline compound are not readily volatile at reaction temperatures but can be evaporated during the continuous reactive extrusion process.

8. A method comprising:
combining lignin, a dialkyl carbonate, and a basic/alkaline compound; and
allowing the dialkyl carbonate and the basic/alkaline compound to modify the lignin to produce an alkoxylate-modified lignin.

9. The method of claim 8, wherein the dialkyl carbonate acts as an alkoxylating reagent and the basic/alkaline compound acts as a catalyst.

10. The method of claim 8, wherein the lignin is modified in a non-aqueous reaction media.

11. The method of claim 8, wherein the basic/alkaline compound includes an aliphatic, heterocyclic or aromatic amine having a pKa dissociation constant in the range of about 9 to about 13.

12. The method of claim 8, wherein the lignin, the dialkyl carbonate, and the basic/alkaline compound are combined in a continuous or semi-continuous reaction process.

13. The method of claim 12, wherein the continuous or semi-continuous reaction process is a continuous reactive extrusion process.

14. The method of claim 13, wherein the dialkyl carbonate and the basic/alkaline compound are not readily volatile at reaction temperatures but can be evaporated from the continuous reactive extrusion process.

15. A method to produce a hydroxyalkoxylated lignin, the method comprising:
using a reactive solvent as a lignin-chemically-modifying reagent, wherein the reactive solvent dissolves un-fractionated kraft lignin at a concentration greater than about thirty percent solids at 100° C. to produce the hydroxyalkoxylated lignin.

16. The method of claim 15, wherein the reactive solvent is propylene carbonate.

17. The method of claim 15, wherein the reactive solvent is a cyclic alkene carbonate or an alkyl carbonate.

18. The method of claim 15, wherein the hydroxyalkoxylated lignin is produced in a non-aqueous reaction media.

19. The method of claim 15, wherein the hydroxyalkoxylated lignin is produced in a continuous or semi-continuous reaction process.

20. The method of claim 15 wherein the hydroxyalkoxylated lignin is produced in a reactive extrusion process.
